(19) United States
(12) Patent Application Publication
(10) Pub. No.: US 2023/0373585 A1
(43) Pub. Date: Nov. 23, 2023

(54) BICYCLE COMPONENT, BICYCLE COMPONENT ASSEMBLY AND CABLE CONNECTOR

(71) Applicant: Shimano Inc., Osaka (JP)

(72) Inventors: Takeshi UEDA, Osaka (JP); Satoshi FUJII, Osaka (JP); Atsuhiro EMURA, Osaka (JP); Shota SUYAMA, Osaka (JP); Yuta MIZUTANI, Osaka (JP); Dai YOKOZAWA, Osaka (JP)

(21) Appl. No.: 18/106,725

(22) Filed: Feb. 7, 2023

Related U.S. Application Data
(63) Continuation-in-part of application No. 17/749,626, filed on May 20, 2022, now abandoned.

(51) Int. Cl. B62J 43/30; B62J 43/20; B62J 1/02; B62K 25/00; B62L 3/00; B62M 25/08; H01R 24/20; H01R 13/50

(52) U.S. Cl. CPC B62J 43/30; B62J 43/20; B62J 1/02; B62K 25/00; B62L 3/00; B62M 25/08; H01R 24/20; H01R 13/50; H02J 7/0063

(57) ABSTRACT

A bicycle component includes a base member, a movable member, a link member, an actuator, and a battery holder. The link member movably couples the movable member to the base member. The actuator is operatively coupled to the link member to move the link member. The battery holder is detachably attached to the link member. The battery holder includes a battery holding portion configured to hold a battery and a flexible element electrically connecting the battery holding portion to the actuator.

### CROSS-REFERENCE TO RELATED APPLICATIONS

This application is a continuation-in-part application of U.S. application Ser. No. 17/749,626, filed May 20, 2022. The entire disclosure of U.S. application Ser. No. 17/749,626 is hereby incorporated herein by reference.

### BACKGROUND

### Technical Field

This disclosure generally relates to a bicycle component, a bicycle component assembly, and a cable connector.

### Background Information

In recent years, some bicycles are provided with electrical bicycle components or devices to make it easier for the rider to operate the bicycle. Examples of such electrical bicycle components include suspensions, transmission devices (e.g., derailleurs, internally geared hubs, etc.) and seatposts. Such electrical bicycle components use electricity from an onboard power source, such as one or more batteries. In some electrical components, one or more of the electrical components share a power supply. On the other hand, electrical components can have its own power supply. The power source for the bicycle component either needs to be replaced or needs to be periodically recharged. In the case where the power source for the bicycle component needs to be periodically recharged, either the battery is plugged into a remote charger, or the battery is removed from the bicycle component and placed on a remote charger.

### SUMMARY

Generally, the present disclosure is directed to various features of a bicycle component having a battery holder for a battery.

In view of the state of the known technology and in accordance with a first aspect of the present disclosure, a bicycle component is provided that basically comprises a base member, a movable member, a link member, an actuator and a battery holder. The link member movably couples the movable member to the base member. The actuator is operatively coupled to the link member to move the link member. The battery holder is detachably attached to the link member. The battery holder includes a battery holding portion configured to hold a battery and a flexible element electrically connecting the battery holding portion to the actuator.

With the bicycle component according to the first aspect, a battery can be easily supported to the link member of the bicycle component and easily electrically connected to the actuator via the battery holder.

In accordance with a second aspect of the present disclosure, the bicycle component according to the first aspect is configured so that the actuator is provided to the base member.

With the bicycle component according to the second aspect, the actuator can be reliably supported and easily connected to the link member for moving the link member, which in turn moves the movable member relative to the base member.

In accordance with a third aspect of the present disclosure, the bicycle component according to the first aspect or the second aspect is configured so that the link member includes a first link and a second link, and the battery holding portion is located at least partially between the first link and the second link.

With the bicycle component according to the third aspect, the movable member can be reliably supported for movement relative to the base member by using two links.

In accordance with a fourth aspect of the present disclosure, the bicycle component according to any one of the first aspect to the third aspect is configured so that the link member includes a first link that is pivotally connected to the base member by a first link pin and pivotally connected to the movable member by a second link pin, and the battery holding portion is located between the first link pin and the second link pin.

With the bicycle component according to the fourth aspect, the links can form a four-bar linkage for controlling the movement of the movable member relative to the base member.

In accordance with a fifth aspect of the present disclosure, the bicycle component according to any one of the first aspect to the fourth aspect is configured so that the battery holding portion is configured to detachably hold the battery.

With the bicycle component according to the fifth aspect, the battery can be easily removed and reinstalled after being recharged, and/or replacement after the battery has reached its useful life.

In accordance with a sixth aspect of the present disclosure, the bicycle component according to any one of the first aspect to the fifth aspect is configured so that the actuator is configured to be connected to an additional electrical cable in a state where the actuator is disconnected from the flexible element.

With the bicycle component according to the sixth aspect, it is possible to supply electric power to the actuator from another power source (e.g., a remotely located battery).

In accordance with a seventh aspect of the present disclosure, the bicycle component according to any one of the first aspect to the sixth aspect is configured so that the flexible element includes at least one of a first electrical cable and a flexible circuit board.

With the bicycle component according to the seventh aspect, a conventional electrical cable or a conventional flexible circuit board can be used to electrically connect the battery to the actuator.

In accordance with an eighth aspect of the present disclosure, a bicycle component is provided that basically comprises an electrical part, a first battery holder, a first electrical connection and a second electrical connection. The first battery holder is configured to hold a first battery. The first electrical connection is configured to be directly connected to a first electrical terminal of the first battery. The second electrical connection is electrically connected to the electrical part and configured to be connected to a second electrical cable electrically connected to a second battery.

With the bicycle component according to the eighth aspect, it is possible to supply electric power to the actuator from either the first battery or the second battery.

In accordance with a ninth aspect of the present disclosure, the bicycle component according to the eighth aspect is configured so that the second electrical connection is configured to be electrically connected to the second battery via a second battery holder, the second battery holder remotely located from the bicycle component.

With the bicycle component according to the ninth aspect, the second battery can be mounted at a location that is remotely located from the bicycle component using the second battery holder.

In accordance with a tenth aspect of the present disclosure, the bicycle component according to the eighth aspect or the ninth aspect further comprises a base member, a movable member and a link member movably coupling to the movable member to the base member.

With the bicycle component according to the tenth aspect, the first battery holder can be conveniently located to one of the base member, the movable member and the link member.

In accordance with an eleventh aspect of the present disclosure, the bicycle component according to the tenth aspect is configured so that the first electrical connection is located at one of the base member, the movable member and the link member, and the second electrical connection is located at the one of the base member, the movable member and the link member.

With the bicycle component according to the eleventh aspect, the first electrical connection can be appropriately located at one of the base member, the movable member and the link member, and the second electrical connection can be appropriately located at the one of the base member, the movable member and the link member.

In accordance with a twelfth aspect of the present disclosure, the bicycle component according to the tenth aspect is configured so that the first electrical connection is located at one of the base member, the movable member and the link member, and the second electrical connection is located at a different one of the base member, the movable member and the link member from the first electrical connection.

With the bicycle component according to the twelfth aspect, the first electrical connection can be appropriately located at one of the base member, the movable member and the link member, and the second electrical connection can be appropriately located at a different one of the base member, the movable member and the link member.

In accordance with a thirteenth aspect of the present disclosure, the bicycle component according to the tenth aspect is configured so that the first electrical connection is located at the link member, and the second electrical connection is located at the base member.

With the bicycle component according to the thirteenth aspect, it is possible to easily electrically connect the first battery to the first electrical connection and easily electrically connect the second battery to the second electrical connection.

In accordance with a fourteenth aspect of the present disclosure, the bicycle component according to the eighth aspect or the ninth aspect further comprises a base member configured to be mounted to a bicycle frame at a mounting point, wherein the second electrical connection is at least partially located further from the mounting point than the first electrical connection.

With the bicycle component according to the fourteenth aspect, the first electrical connection and the second electrical connection can be appropriately located with respect to the mounting point of the base member to the bicycle frame.

In accordance with a fifteenth aspect of the present disclosure, the bicycle component according to the eighth aspect or the ninth aspect further comprises a base member configured to be mounted to a bicycle frame at a mounting point, wherein the first electrical connection is at least partially located further from the mounting point than the second electrical connection.

With the bicycle component according to the fifteenth aspect, the first electrical connection and the second electrical connection can be appropriately located with respect to the mounting point of the base member to the bicycle frame.

In accordance with a sixteenth aspect of the present disclosure, the bicycle component according to any one of the eighth aspect to the fifteenth aspect is configured so that the second electrical connection includes an electrical connector.

With the bicycle component according to the sixteenth aspect, an electrical cable can be easily connected to the second electrical connection.

In accordance with a seventeenth aspect of the present disclosure, the bicycle component according to any one of the eighth aspect to the sixteenth aspect further comprises an electronic controller configured to switch supply of electrical power to the electrical part from one of the first battery and the second battery to the other one the first battery and the second battery upon determining a power level of one of the first battery and the second battery is lower than the other one the first battery and the second battery while in a state where the first battery is electrically connected to the first electrical connection and the second battery is electrically connected to the second electrical connection.

With the bicycle component according to the seventeenth aspect, it is possible to switch supply of electrical power to the electrical part from one of the first battery and the second battery to the other one the first battery and the second battery to ensure that sufficient electric power is available for the electrical part.

In accordance with an eighteenth aspect of the present disclosure, the bicycle component according to any one of the eighth aspect to the seventeenth aspect is configured so that the first battery holder includes the first electrical connection and a first electrical cable that is configured to be connected to the second electrical connection.

With the bicycle component according to the eighteenth aspect, it is possible to selectively connect either the first battery or the second battery to the electrical part using the same electrical connection.

In accordance with a nineteenth aspect of the present disclosure, the bicycle component according to any one of the eighth aspect to the eighteenth aspect is configured so that the first battery has a first electric power capacity, and the second battery has a second electric power capacity larger than the first electric power capacity.

With the bicycle component according to the nineteenth aspect, it is possible to provide a smaller capacity battery on the bicycle component and provide a larger capacity battery at a remote location on the bicycle.

In accordance with a twentieth aspect of the present disclosure, the bicycle component according to any one of the eighth aspect to the nineteenth aspect further comprises a circuitry configured to reduce at least one of voltage and current, and the circuitry being disposed at one of the second electrical connection, the second battery holder, and the electrical part.

With the bicycle component according to the twentieth aspect, it is possible to control the voltage and/or the current from the second battery to an appropriate level.

In accordance with a twenty-first aspect of the present disclosure, a bicycle component is provided that basically comprises an electrical part, a first battery holder, an electrical connection and a first electrical cable. The first battery holder is configured to hold a first battery. The electrical connection is electrically connected to the electrical part. The first electrical cable is electrically connected to at least one electrical terminal of the first battery holder. The electrical connection is configured to be selectively connected to the first electrical cable and a second electrical cable electrically connected to a second battery. The electrical connection is configured to be connected to the first electrical cable in a state where the second electrical cable is electrically disconnected from the electrical connection. The electrical connection is configured to be connected to the second electrical cable of the second battery in a state where the first electrical cable is electrically disconnected from the electrical connection.

With the bicycle component according to the twenty-first aspect, it is possible to easily switch the electric power being supplied to the electrical part from the first battery to being supplied from the second battery using the same electrical connection.

In accordance with a twenty-second aspect of the present disclosure, the bicycle component according to the twenty-first aspect is configured so that the first electrical cable has a first electrical connector, and the second electrical cable has a second electrical connector having a same structure as the first electrical connector.

With the bicycle component according to the twenty-second aspect, it is possible to easily switch the electric power being supplied to the electrical part from the first battery to being supplied from the second battery using the same electrical connection.

In accordance with a twenty-third aspect of the present disclosure, a bicycle component assembly comprises the bicycle component according to the twenty-first aspect or the twenty-second aspect, and further comprises a second battery holder configured to hold a second battery. The second battery holder is remotely located from the bicycle component.

With the bicycle component assembly according to the twenty-third aspect, the second battery can be mounted at a location that is remotely located from the bicycle component using the second battery holder.

In accordance with a twenty-fourth aspect of the present disclosure, the bicycle component assembly according to the twenty-third aspect is configured so that the electrical connection is connected to the first electrical cable in a state where the first battery is attached to the first battery holder, and the second battery is attached to the second battery holder such that the first electrical cable can be disconnected from the electrical connection and the second electrical cable can be connected to the electrical connection.

With the bicycle component assembly according to the twenty-fourth aspect, it is possible to easily switch the electric power being supplied to the electrical part from the first battery to being supplied from the second battery using the same electrical connection.

In accordance with a twenty-fifth aspect of the present disclosure, the bicycle component assembly according to the twenty-third aspect is configured so that the electrical connection is connected to the second electrical cable in a state where the second battery is attached to the second battery holder, and the first battery is attached to the first battery holder such that the second electrical cable can be disconnected from the electrical connection and the first electrical cable can be connected to the electrical connection.

With the bicycle component assembly according to the twenty-fifth aspect, it is possible to easily switch the electric power being supplied to the electrical part from the first battery to being supplied from the second battery using the same electrical connection.

In accordance with a twenty-sixth aspect of the present disclosure, the bicycle component assembly according to any one of the twenty-third aspect to the twenty-fifth aspect further comprises a circuitry configured to reduce at least one of voltage and current. The circuitry is disposed at one of the electrical connection, the second battery holder, and the electrical part.

With the bicycle component assembly according to the twenty-sixth aspect, it is possible to control the voltage and/or the current from the second battery to an appropriate level.

In accordance with a twenty-seventh aspect of the present disclosure, the bicycle component according to any one of the twenty-first aspect to the twenty-sixth aspect further comprises a base member configured to be mounted to a bicycle frame at a mounting point, wherein the electrical connection is at least partially located further from the mounting point than the first battery holder.

With the bicycle component according to the twenty-seventh aspect, the first battery holder and the electrical connection can be appropriately located with respect to the mounting point of the base member to the bicycle frame.

In accordance with a twenty-eighth aspect of the present disclosure, the bicycle component according to any one of the twenty-first aspect to the twenty-sixth aspect further comprises a base member configured to be mounted to a bicycle frame at a mounting point, wherein the first battery holder is at least partially located further from the mounting point than the electrical connection.

With the bicycle component according to the twenty-eighth aspect, the first battery holder and the electrical connection can be appropriately located with respect to the mounting point of the base member to the bicycle frame.

In accordance with a twenty-ninth aspect of the present disclosure, the bicycle component according to any one of the eighth aspect to the twenty-eighth aspect is configured so that the second electrical cable is configured to be used for power line communication.

With the bicycle component according to the twenty-ninth aspect, it is possible to communicate signals to the bicycle component via the second electrical cable.

In accordance with a thirtieth aspect of the present disclosure, the bicycle component according to any one of the first aspect to the twenty-ninth aspect is configured so that the bicycle component is a bicycle component other than a drive unit.

With the bicycle component according to the thirtieth aspect, it is possible to provide the battery to a bicycle component other than a drive unit.

In accordance with a thirty-first aspect of the present disclosure, the bicycle component according to any one of the first aspect to the thirtieth aspect is configured so that the bicycle component includes one of an electric adjustable seatpost, an electric front suspension, an electric rear suspension, an electric front brake, an electric rear brake, an electric shift lever, an electric front derailleur, and an electric rear derailleur.

With the bicycle component according to the thirty-first aspect, it is possible to a battery to any one of an electric adjustable seatpost, an electric front suspension, an electric rear suspension, an electric front brake, an electric rear brake, an electric shift lever, an electric front derailleur, and an electric rear derailleur.

In accordance with a thirty-second aspect of the present disclosure, a bicycle component is provided that basically comprises an electrical part and an electrical connection. The electrical connection is electrically connected to the electrical part. The electrical connection is configured to be selectively and electrically connected to a first cable connector of a first electrical cable and a second cable connector of a second electrical cable. The first cable connector has a first shape and the second cable connector has a second shape. The second shape is different from the first shape.

With the bicycle component according to the thirty-second aspect, the bicycle component can be connected to other components using either the first electrical cable or the second electrical cable.

In accordance with a thirty-third aspect of the present disclosure, the bicycle component according to the thirty-second aspect is configured so that the first electrical cable is configured to be electrically connected to a first battery. The second electrical cable is configured to be electrically connected to a second battery, the second battery having a voltage higher than a voltage of the first battery.

With the bicycle component according to the thirty-third aspect, the bicycle component can be connected to batteries having different voltage ratings.

In accordance with a thirty-fourth aspect of the present disclosure, the bicycle component according to the thirty-third aspect is configured so that the second battery is configured to supply electrical power to a drive unit that is configured to assist in propulsion of a bicycle.

With the bicycle component according to the thirty-fourth aspect, the bicycle component can be indirectly coupled to the second battery via the drive unit such that the second battery supplies electrical power to both the bicycle component and the drive unit.

In accordance with a thirty-fifth aspect of the present disclosure, the bicycle component according to the thirty-third aspect or the thirty-fourth aspect is configured so that the first battery is configured to be attached to the bicycle component.

With the bicycle component according to the thirty-fifth aspect, the bicycle component can be a self-contained by having a built-in battery. In this way, the bicycle component can be ready to use without the battery having to be mounted separately to the bicycle.

In accordance with a thirty-sixth aspect of the present disclosure, the bicycle component according to any one of the thirty-second aspect to the thirty-fifth aspect is configured so that the electrical connection includes an electrical contact portion and a connector housing defining a connector receiving recess. The electrical contact portion is at least partly disposed in the connector receiving recess.

With the bicycle component according to the thirty-sixth aspect, the electrical contact portion is protected by being disposed in the connector receiving recess of the connector housing.

In accordance with a thirty-seventh aspect of the present disclosure, the bicycle component according to the thirty-sixth aspect is configured so that the connector receiving recess includes a first recess having a first width and a second recess having a second width. The second width is larger than the first width.

With the bicycle component according to the thirty-seventh aspect, the connector receiving recess can receive the first cable connector having the first shape and the second cable connector having the second shape.

In accordance with a thirty-eighth aspect of the present disclosure, the bicycle component according to the thirty-seventh aspect is configured so that the second recess is configured to receive a connector abutment portion of the second cable connector to allow the second cable connector to electrically connect of the electrical connection.

With the bicycle component according to the thirty-eighth aspect, the connector receiving recess can reliably receive the connector abutment portion of the second cable connector.

In accordance with a thirty-ninth aspect of the present disclosure, the bicycle component according to the thirty-seventh aspect or the thirty-eighth aspect further comprises a housing accommodating the electrical part. The connector housing is integrally formed with the housing.

With the bicycle component according to the thirty-ninth aspect, the cost of manufacturing the bicycle component can be reduced by providing a connector housing that is integrally formed with the housing as compared to providing a connector housing that is separate from the housing.

In accordance with a fortieth aspect of the present disclosure, the bicycle component according to any one of the thirty-second aspect to the thirty-ninth aspect is configured so that the bicycle component includes an electric rear derailleur having a base member configured to be mounted to a bicycle frame. The electrical part is provided at the base member.

With the bicycle component according to the fortieth aspect, the bicycle component can be used to change gears of the bicycle.

In accordance with a forty-first aspect of the present disclosure, the bicycle component according to any one of the thirty-second aspect to the fortieth aspect is configured so that the electrical part includes a reduction circuit reducing at least one of voltage and current.

With the bicycle component according to the forty-first aspect, the bicycle component can be connected to batteries having different voltage ratings.

In accordance with a forty-second aspect of the present disclosure, a cable connector is provided for an electrical cable that is configured to be connected to a first bicycle component. The cable connector comprises a connector contact portion and an abutment portion. The connector contact portion is configured to electrically contact with a first electrical contact portion of the first bicycle component in a state where the cable connector is connected to the first bicycle component. The abutment portion is configured to abut a second connector housing of a second bicycle component so as to prevent electrical contact with a second electrical contact portion of the second bicycle component.

With the cable connector according to the forty-second aspect, the cable connector is prevented from being electrically connected to the second bicycle component.

In accordance with a forty-third aspect of the present disclosure, the cable connector according to the forty-second aspect further comprises a cable connector housing covering the connector contact portion. The cable connector has a tubular shape having a center axis. The abutment portion includes at least one flange extending in a circumferential direction relative to the center axis of the cable connector housing.

With the cable connector according to the forty-third aspect, the connector contact portion is protected, and the abutment portion reliably prevents electrically connection to the second bicycle component.

In accordance with a forty-fourth aspect of the present disclosure, the cable connector according to the forty-third aspect further comprises a cable connector housing covering the connector contact portion. The cable connector has a tubular shape having a center axis. The abutment portion includes at least two flanges intermittently disposed in a circumferential direction relative to the center axis of the cable connector housing.

With the cable connector according to the forty-fourth aspect, the connector contact portion is protected, and the abutment portion reliably prevents electrically connection to the second bicycle component.

In accordance with a forty-fifth aspect of the present disclosure, the cable connector according to the forty-third aspect or the forty-fourth aspect is configured so that the cable connector housing has a shape, which is different from a second shape of another cable connector configured to be electrically connected to the second electrical contact portion of the second bicycle component.

With the cable connector according to the forty-fifth aspect, the cable connector housing prevents electrically connection to the second bicycle component that is configured to be electrically connected to another cable connector.

In accordance with a forty-sixth aspect of the present disclosure, the cable connector according to any one of the forty-third aspect to the forty-fifth aspect is configured so that the cable connector housing has a third width. The abutment portion has a fourth width. The fourth width is larger than the third width.

With the cable connector according to the forty-sixth aspect, the cable connector housing is configured to prevent electrically connection to the second bicycle component.

Also, other objects, features, aspects and advantages of the disclosed bicycle component will become apparent to those skilled in the art from the following detailed description, which, taken in conjunction with the annexed drawings, discloses preferred embodiments of the bicycle component.

### BRIEF DESCRIPTION OF THE DRAWINGS

Referring now to the attached drawings which form a part of this original disclosure.

FIG. 1 is a side elevational view of bicycle that is equipped with bicycle components in accordance with illustrative embodiments of the present disclosure.

FIG. 2 is an outline of a bicycle equipped with the bicycle components illustrated in FIG. 1 as viewed from in front of the bicycle and along a longitudinal direction to show a bicycle center plane vertically bisecting the frame of the bicycle.

FIG. 3 is an overall schematic block diagram of a bicycle component system including at least one bicycle component, a user operable interface and a second battery holder in accordance with one illustrated embodiment of the present disclosure.

FIG. 4 is an overall schematic block diagram of the bicycle component system illustrated in FIG. 3, but where the first battery holder and the first battery have been removed.

FIG. 5 is an outer side elevational view of the bicycle derailleur (i.e., a bicycle component) having a first battery, and a diagrammatic illustration of the second battery holder having a second battery electrically coupled to the first battery of the bicycle derailleur.

FIG. 6 is an inner side elevational view of the bicycle derailleur illustrated in FIG. 5, and a diagrammatic illustration of the second battery electrically coupled to the first battery of the bicycle derailleur.

FIG. 7 is a perspective view of an outer link of the bicycle derailleur illustrated in FIGS. 5 and 6, in which the outer link includes a first battery holder for holding the first battery.

FIG. 8 is another perspective view of the outer link, the first battery holder and the first battery illustrated in FIG. 7.

FIG. 9 is another perspective view of the outer link, the first battery holder and the first battery illustrated in FIGS. 7 and 8.

FIG. 10 is an inner side elevational view of the outer link, the first battery holder for and the first battery illustrated in FIGS. 7 to 89.

FIG. 11 is a perspective view, similar to FIG. 9, of the outer link, the first battery holder and the first battery illustrated in FIGS. 7 to 10, but in which a latch of a locking member has been pivoted to an unlatched position.

FIG. 12 is a bottom plan view of the outer link, the first battery holder and the first battery illustrated in FIG. 8, where the latch of the locking member has been pivoted to the unlatched position.

FIG. 13 is a bottom perspective view of the outer link, the first battery holder and the first battery illustrated in FIGS. 7 to 12, but in which the locking member has been pivoted to a non-holding position.

FIG. 14 is a bottom plan view of the outer link, the first battery holder and the first battery illustrated in FIG. 13, where the locking member has been pivoted to the non-holding position.

FIG. 15 is an enlarged bottom plan view of the outer link, the first battery holder and the first battery illustrated in FIG. 14, where the locking member has been pivoted to the non-holding position.

FIG. 16 is a partial exploded perspective view of the outer link, the first battery holder and the first battery illustrated in FIGS. 7 to 15.

FIG. 17 is a bottom plan view of the outer link and the first battery holder illustrated in FIG. 13, where the locking member has been pivoted to the non-holding position and the first battery has been removed.

FIG. 18 is a partial exploded perspective view of the outer link and the first battery holder illustrated in FIG. 17.

FIG. 19 is another partial exploded perspective view of the outer link and the first battery holder illustrated in FIGS. 17 and 18.

FIG. 20 is a perspective view of the first battery of the bicycle derailleur illustrated in FIGS. 5 and 6.

FIG. 21 is an inner side elevational view of the first battery illustrated in FIG. 20.

FIG. 22 is an outer side elevational view of the first battery illustrated in FIGS. 20 and 21.

FIG. 23 is a top plan view of the first battery illustrated in FIGS. 20 to 22.

FIG. 24 is a bottom plan view of the first battery illustrated in FIGS. 20 to 23.

FIG. 25 is a first side elevational view of the first battery illustrated in FIGS. 20 to 24.

FIG. 26 is a first side elevational view of the first battery illustrated in FIGS. 20 to 25.

FIG. 27 is a cross sectional view of the first battery illustrated in FIGS. 20 to 26 as seen along section line 27-27 in FIG. 23.

FIG. 28 is a cross sectional view of the first battery illustrated in FIGS. 20 to 26 as seen along section line 28-28 in FIG. 27.

FIG. 29 is an overall schematic block diagram of a bicycle component system including at least one bicycle component having a battery holder and a user operable interface.

FIG. 30 is an overall schematic block diagram of a bicycle component system including at least one bicycle component, a user operable interface and a second battery holder in accordance with another embodiment.

FIG. 31 is an overall schematic block diagram of a bicycle component system including at least one bicycle component, a user operable interface and a second battery holder in accordance with another embodiment.

FIG. 32 is an outer side elevational view of the bicycle derailleur (i.e., a bicycle component) having a first battery and a diagrammatic illustration of a second battery holder having a second battery in accordance with another embodiment in which the first battery is electrically coupled to the bicycle derailleur and the second battery is electrically coupled to the drive unit.

FIG. 33 is an inner side elevational view of the bicycle derailleur and the diagrammatic illustration of the second battery holder illustrated in FIG. 32.

FIG. 34 is an outer side elevational view of the bicycle derailleur and the diagrammatic illustration of the second battery holder illustrated in FIGS. 32 and 33 in which the second battery is electrically coupled to the bicycle derailleur via the drive unit.

FIG. 35 is an inner side elevational view of the bicycle derailleur and the diagrammatic illustration of the second battery holder illustrated in FIGS. 32 to 34 in which the second battery is electrically coupled to the bicycle derailleur via the drive unit.

FIG. 36 is a perspective view of a portion of a first electrical cable having a first cable connector that is configured to electrically connect to the first battery to the actuator of the bicycle derailleur illustrated in FIGS. 32 to 35.

FIG. 37 is a side elevational view of the portion of the first electrical cable and the first cable connector illustrated in FIG. 36.

FIG. 38 is a longitudinal cross sectional view of the first cable connector illustrated in FIGS. 36 and 37.

FIG. 39 is a perspective view of a portion of a second electrical cable having a second cable connector that is configured to electrically connect the second battery to the actuator of the bicycle derailleur illustrated in FIGS. 32 to 35.

FIG. 40 is a side elevational view of the portion of the second electrical cable and the second cable connector illustrated in FIG. 39.

FIG. 41 is a longitudinal cross sectional view of the second cable connector illustrated in FIGS. 39 and 40.

FIG. 42 is an overall schematic block diagram of a first bicycle component assembly having the bicycle derailleur illustrated in FIGS. 32 to 35 being configured to be selectively connected to either the first battery or the second battery.

FIG. 43 is a perspective view of a portion of the actuator housing of the bicycle derailleur illustrated in FIGS. 32 to 35 in which the actuator housing includes a connector housing that is configured to selectively receive either the first electrical cable or the second electrical cable.

FIG. 44 is a cross sectional view of the connector housing of the bicycle derailleur illustrated in FIGS. 32 to 35 as seen along section line 44-44 in FIG. 43.

FIG. 45 is a cross sectional perspective view of the connector housing illustrated in FIG. 44.

FIG. 46 is a cross sectional view, similar to FIG. 45, of the connector housing, but in which the first electrical cable has been electrically connected to the cable connector.

FIG. 47 is a cross sectional view, similar to FIGS. 45 and 46, of the connector housing, but in which the second electrical cable has been electrically connected to the cable connector.

FIG. 48 is an overall schematic block diagram of a second bicycle component assembly having the bicycle derailleur illustrated in FIGS. 32 to 35 but in which the bicycle derailleur has been modified so that the first electrical cable can be electrically connected to the electrical connection of the actuator unit, but the second electrical cable cannot be electrically connected to the electrical connection of the actuator unit.

FIG. 49 is a perspective view of a portion of an alternate actuator housing for the bicycle derailleur illustrated in FIGS. 32 to 35 in which the alternate actuator housing includes an electrical connection that is configured to be electrically connected to the first electrical cable, but not electrically connected the second electrical cable.

FIG. 50 is a cross sectional view of the alternate connector housing of the bicycle derailleur illustrated in FIGS. 32 to 35 as seen along section line 50-50 in FIG. 49.

FIG. 51 is a cross sectional perspective view of the alternate connector housing illustrated in FIG. 50.

FIG. 52 is a cross sectional view, similar to FIG. 51, of the alternate connector housing, but in which the first electrical cable has been electrically connected to the cable connector.

FIG. 53 is a cross sectional view, similar to FIGS. 51 and 52, of the connector housing, but in which the second electrical cable has been partially inserted into the connector housing, but is prevented from being fully inserted such that no electrical connection is established with the second electrical cable.

FIG. 54 is a perspective view of a portion of an alternate second electrical cable having an alternate second cable connector that is configured to electrically connect the second battery to the actuator of the bicycle derailleur illustrated in FIGS. 32 to 35.

FIG. 55 is a side elevational view of the portion of the alternate second electrical cable and the alternate second cable connector illustrated in FIG. 54.

FIG. 56 is a longitudinal cross sectional view of the second cable connector illustrated in FIGS. 54 and 56.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

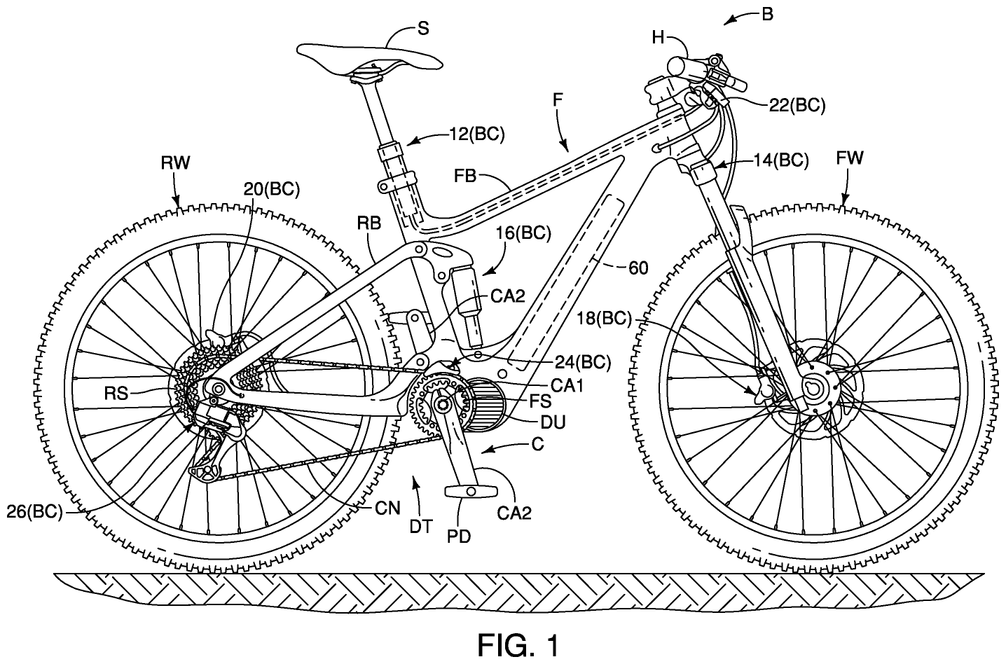

Referring initially to FIG. 1, a bicycle B is illustrated that is equipped with a bicycle component assembly 10 having a plurality of electrical bicycle components BC (hereinafter referred to as simply “bicycle components BC”) in accordance with illustrative embodiments. Here, the bicycle B is illustrated as an electric assist bike. However, the bicycle component assembly 10 can be applied to any other type of bicycles such as, for example, a mountain bike, a cyclocross bicycle, a road bicycle, a city bike, a cargo bike, and a recumbent bike.

As shown in FIG. 1, the bicycle B includes a bicycle frame F that is supported by a rear wheel RW and a front wheel FW. The bicycle frame F basically includes a front frame body FB and a rear frame body RB (a swing arm). The bicycle frame F is also provided with a handlebar H for steering the bicycle B. The bicycle B further includes a drivetrain DT. Here, for example, the drivetrain DT is a chain-drive type that includes a crank C, a plurality of front sprockets FS, a plurality of rear sprockets RS and a chain CN. The crank C includes a crank axle CA1 and a pair of crank arms CA2. The crank axle CA1 is rotatably supported to the front frame body FB. The crank arms CA2 are provided on opposite ends of the crank axle CA1. A pedal PD is rotatably coupled to the distal end of each of the crank arms CA2. The front sprocket FS is provided on the crank C to rotate integrally with the crank axle CA1. The rear sprockets RS are provided on a hub of the rear wheel RW. The chain CN runs around the front sprocket FS and the rear sprockets RS. A human driving force is applied to the pedals PD by a rider of the bicycle B such that the driving force is transmitted via the front sprocket FS, the chain CN and the rear sprockets RS to the rear wheel RW. While the drivetrain DT is illustrated as a chain-drive type of drivetrain, the drivetrain DT can be selected from any type of drivetrain, and can be a belt-drive type or a shaft-drive type.

Here, the bicycle B further includes a drive unit DU that is configured to apply a propulsion force to the crank axle CA1 of the bicycle B. The drive unit DU has an electric motor provided in a housing that is mounted to the front frame body FB. The electric motor of the drive unit DU is, for example, a brushless motor. The drive unit DU can include a speed reducer connected to an output shaft of the motor. In the present embodiment, the housing of the drive unit DU rotatably supports the crank axle CA1. Preferably, a one-way clutch is provided in a power transmission path between the motor of the drive unit DU and the crank axle CA1 to restrict transmission of a rotational force of the crank C to the motor of the drive unit DU in a case where the crank axle CA1 is rotated in a direction in which the bicycle B moves forward.

In the illustrated embodiment, the bicycle components BC of the bicycle B includes an electric adjustable seatpost 12, an electric front suspension 14, an electric rear suspension 16, an electric front brake 18, an electric rear brake 20, an electric shift lever 22, an electric front derailleur 24, and an electric rear derailleur 26. Thus, the term “bicycle component BC” will be used herein to generically refer to all of the electrical bicycle components BC of the bicycle B (i.e., the electric adjustable seatpost 12, the electric front suspension 14, the electric rear suspension 16, the electric front brake 18, the electric rear brake 20, the electric shift lever 22, the electric front derailleur 24, and the electric rear derailleur 26).

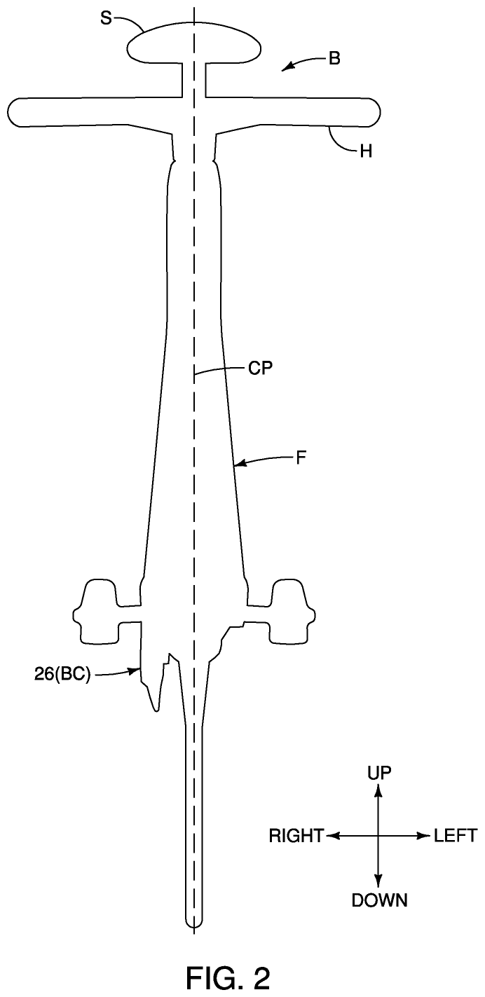

Referring to FIG. 2, an outline of the bicycle B is illustrated as viewed from in front of the bicycle B and along a longitudinal direction to show a bicycle center plane CP vertically bisecting a frame F of the bicycle B. The bicycle center plane CP passes through a center of the bicycle frame F in a width direction of the bicycle frame F. The bicycle center plane CP separates a left side from a right side of the bicycle B. The following directional terms “front,” “rear,” “forward,” “rearward,” “left,” “right,” “lateral,” “longitudinal”, “upward,” and “downward,” as well as any other similar directional terms, refer to those directions which are determined on the basis of a rider sitting upright on the seat S of the bicycle B while facing the handlebar H of the bicycle B.

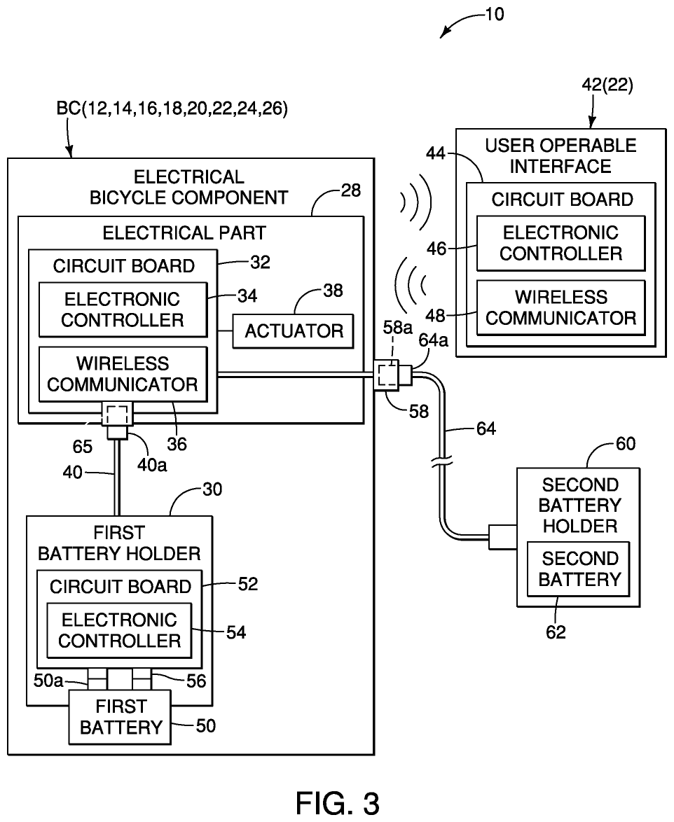

Referring now to FIG. 3, the bicycle component assembly 10 is schematically illustrated in connection with one of the bicycle components BC. Thus, the bicycle component assembly 10 comprises the bicycle component BC. In FIG. 3, the bicycle component BC is a bicycle component other than a drive unit. The bicycle component BC includes one of the electric adjustable seatpost 12, the electric front suspension 14, the electric rear suspension 16, the electric front brake 18, the electric rear brake 20, the electric shift lever 22, the electric front derailleur 24, and the electric rear derailleur 26. However, the bicycle component BC can include other bicycle components other than a drive unit.

In any case, the bicycle component assembly 10 comprises the bicycle component BC. Basically, for each of the bicycle components BC, the bicycle component BC comprises an electrical part 28 and a first battery holder 30. For example, as diagrammatically illustrated in FIG. 3, the electrical part 28 includes a circuit board 32. The bicycle component BC further comprises an electronic controller 34. In the illustrated embodiment, the electronic controller 34 is provided on the circuit board 32. Also, in the illustrated embodiment, the bicycle component BC further comprises a wireless communicator 36 and an actuator 38. The wireless communicator 36 can be provided on the circuit board 32, while the actuator 38 is electrically connected to the circuit board 32.

The electronic controller 34 is preferably a microcomputer or central processing unit (CPU) that includes at least one processor and at least one computer storage device (i.e., computer memory devices). The electronic controller 34 formed of one or more semiconductor chips that are mounted on the circuit board 32. The term “electronic controller” as used herein refers to hardware that executes a software program, and does not include a human being. The memory device stores programs used by the electronic controller 34. The memory device is any computer storage device or any computer readable medium with the sole exception of a transitory propagating signal. For example, the memory device can be nonvolatile memory and volatile memory, and can includes a ROM (Read Only Memory) device, a RAM (Random Access Memory) device, a hard disk, a flash drive, etc.

The first battery holder 30 is electrically connected to the electrical part 28 to supply electric power to the circuit board 32, the electronic controller 34, the wireless communicator 36 and the actuator 38. In particular, the first battery holder 30 is electrically connected to the electrical part 28 by a flexible element 40 which includes at least one of a first electrical cable and a flexible circuit board. Preferably the flexible element 40 is a first electrical cable having a first electrical connector 40a.

The term “wireless communicator” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. Here, the wireless communicator 36 is configured to at least receive a wireless signal. Preferably, the wireless communicator 36 is a two-way wireless transceiver that conducts two-way wireless communications using the wireless receiver for wirelessly receiving shift signals and a wireless transmitter for wirelessly transmitting data. In the present embodiment, the wireless communicator 36 can wirelessly communicate with other ones of the bicycle components BC. The wireless control signals of the wireless communicator 36 can be radio frequency (RF) signals, ultra-wide band communication signals, radio frequency identification (RFID), ANT+ communications, or Bluetooth® communications or any other type of signal suitable for short range wireless communications as understood in the bicycle field. It should also be understood that the wireless communicator 36 can transmit the signals at a particular frequency and/or with an identifier such as a particular code, to distinguish the wireless control signal from other wireless control signals. In this way, the bicycle component BC can recognize which control signals are to be acted upon and which control signals are not to be acted upon. Thus, the bicycle component BC can ignore the control signals from other wireless communicators of other bicycle components BC.

The bicycle component assembly 10 further includes a user operable interface 42 for operating the bicycle component BC. In the case of the electric rear derailleur 26, the electric shift lever 22 corresponds to the user operable interface 42 in FIG. 3. As diagrammatically illustrated in FIG. 3, the user operable interface 42 is configured to wirelessly communicate with the bicycle component BC. In such a case, the bicycle component BC includes, for example, a circuit board 44, an electronic controller 46 and a wireless communicator 48. Alternatively, the user operable interface 42 can be connected to the bicycle component BC by a cable for transmitting control signals.

The electric adjustable seatpost 12 is configured to adjust the height of the seat S relative to the front frame body FB. The electric adjustable seatpost 12 includes an electric actuator for extending and retracting a pair tubular members to adjust the height of the seat S relative to the front frame body FB. The electric actuator constitutes at least a part of the electrical part 28 of the electric adjustable seatpost 12.

Here, the electric front suspension 14 is pivotally coupled at its upper end to the front frame body FB, and rotatably supports the front wheel FW at its lower end. The electric front suspension 14 is a front suspension fork that is pivotally coupled to the front frame body FB at its upper end, and that rotatably supports the front wheel FW at its lower end. The electric front suspension 14 absorbs shock transmitted from the front wheel FW. The electric front suspension 14 includes an electric actuator for selectively adjusting at least one of a stiffness, including a locking out position, and a stroke length. Thus, the electric front suspension 14 is an electrically adjustable suspension in which the stiffness and/or stoke length can be adjusted. The electric actuator constitutes at least a part of the electrical part 28 of the electric front suspension 14.

The electric rear suspension 16 is operatively disposed between the front frame body FB and the rear frame body RB, which is swingably mounted to a rear section of the front frame body FB such that the rear frame body RB can pivot with respect to the front frame body FB. The rear wheel RW is mounted to a rear end of the rear frame body RB. The electric rear suspension 16 is provided between the front frame body FB and the rear frame body RB to control the movement of the rear frame body RB with respect to the front frame body FB. Namely, the electric rear suspension 16 absorbs shock transmitted from the rear wheel RW. The electric rear suspension 16 includes an electric actuator for selectively adjusting at least one of a stiffness, including a locking out position, and a stroke length. Thus, the electric rear suspension 16 is an electrically adjustable suspension in which the stiffness and/or stoke length can be adjusted. The electric actuator constitutes at least a part of the electrical part 28 of the electric rear suspension 16.

The electric front brake 18 is provided to the lower tubular member of the front suspension 14. The electric front brake 18 is configured to selectively engage a brake rotor attached of the hub of the front wheel FW. The electric front brake 18 includes an electric actuator for engaging the brake pads against the brake rotor of the front wheel FW. The electric actuator constitutes the electrical part 28 of the electric front brake 18.

The electric rear brake 20 is provided to the rear frame body RB. The electric rear brake 20 is configured to selectively engage a brake rotor attached of the hub of the rear wheel RW. The electric rear brake 20 includes an electric actuator for engaging the brake pads against the brake rotor of the rear wheel RW. The electric actuator constitutes at least a part of the electrical part 28 of the electric rear brake 20.

The electric shift lever 22 is an electric operating device that is configured with one or more operating levers that operate electrical switches for operating the electric front derailleur 24 and the electric rear derailleur 26. The electrical switches constitute electric rear derailleur 26 of the electrical part 28 of the electric shift lever 22. However, the electric shift lever 22 can be replaced with other types of user operable interfaces having one or more operating members such as levers and/or buttons that operate electrical switches for operating the electric front derailleur 24 and the electric rear derailleur 26. Preferably, the bicycle B is provided with other user operable interfaces for operating the other bicycle components BC of the bicycle B.

The electric front derailleur 24 is configured to the chain CN between the front sprockets FS in response to either an automatic shift signal from a cycle computer, or a user inputted shift signal from the electric shift lever 22. The electric front derailleur 24 includes a chain cage that is moved by an electric actuator. The electric actuator constitutes at least a part of the electrical part 28 of the electric front derailleur 24.

The electric rear derailleur 26 is configured to the chain CN between the rear sprockets RS in response to either an automatic shift signal from a cycle computer, or a user inputted shift signal from the electric shift lever 22. The electric rear derailleur 26 includes a chain cage that is moved by an electric actuator. The electric actuator constitutes at least a part of the electrical part 28 of the electric rear derailleur 26.

As diagrammatically illustrated in FIG. 3, the first battery holder 30 is configured to hold a first battery 50. Preferably, the first battery 50 is held by the first battery holder 30 to be removable and replaceable. In this way, the first battery 50 can be removed from the bicycle component BC, and then be recharged and reinstalled to the first battery holder 30 of the bicycle component BC. Here, for example, as diagrammatically illustrated in FIG. 3, the first battery holder 30 includes a circuit board 52 having an electronic controller 54 disposed thereon. The circuit board 52 and the electronic controller 54 are electrically connected to the flexible element 40. Thus, the circuit board 52 and the electronic controller 54 are electrically connected to the electrical part 28 via the flexible element 40 (e.g., the first electrical cable 40 in the illustrated embodiment).

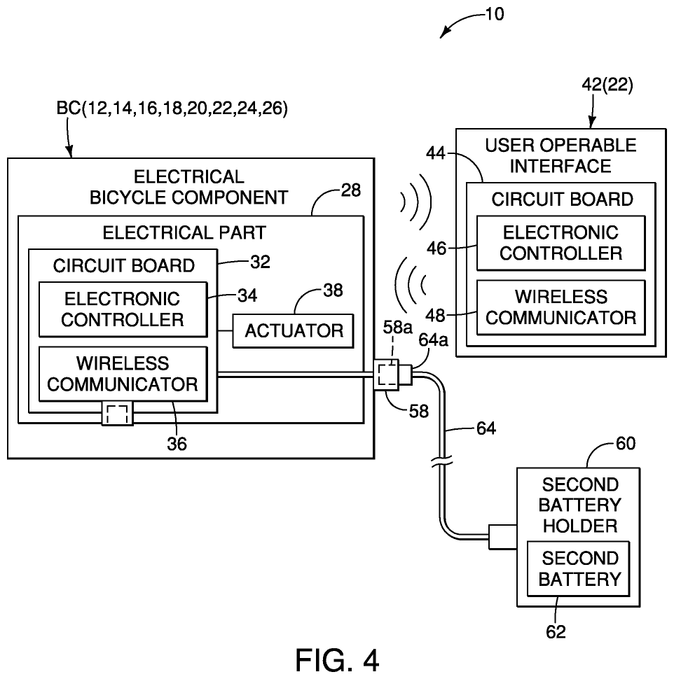

As diagrammatically illustrated in FIG. 4, the first battery holder 30 and the first battery 50 can be removed from the bicycle component BC as explained below. In this way, as explained below, the bicycle component BC can receive electric power from a remotely located power source when the first battery holder 30 and the first battery 50 have been removed from the bicycle component BC. However, it is also acceptable for the first battery holder 30 and the first battery 50 to be configured such that the first battery 50 can be removed while the first battery holder 30 remains on the electrical bicycle component BC. Moreover, it is also acceptable for the first battery holder 30 to include two or more parts such that at least one part of the first battery holder 30 remains on the electrical bicycle component BC and at least one part of the first battery holder 30 remains attached to the first battery 50 when the first battery 50 is removed from the bicycle component BC.

The electronic controller 54 is preferably a microcomputer or central processing unit (CPU) that includes at least one processor and at least one computer storage device (i.e., computer memory devices). The electronic controller 54 formed of one or more semiconductor chips that are mounted on the circuit board 52. The memory device stores programs used by the electronic controller 54. The memory device is any computer storage device or any computer readable medium with the sole exception of a transitory propagating signal. For example, the memory device can be nonvolatile memory and volatile memory, and can includes a ROM (Read Only Memory) device, a RAM (Random Access Memory) device, a hard disk, a flash drive, etc.

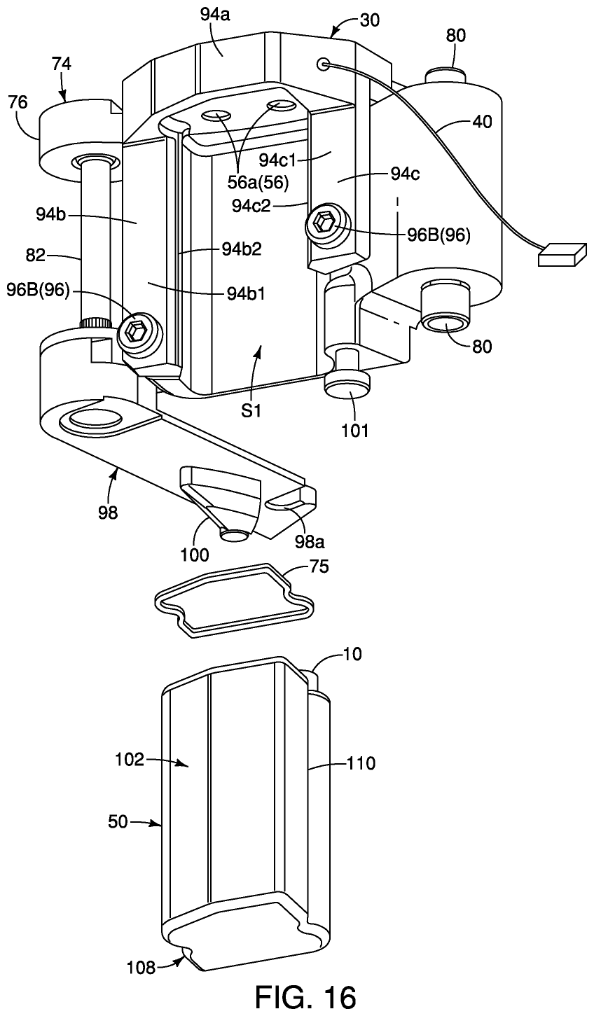

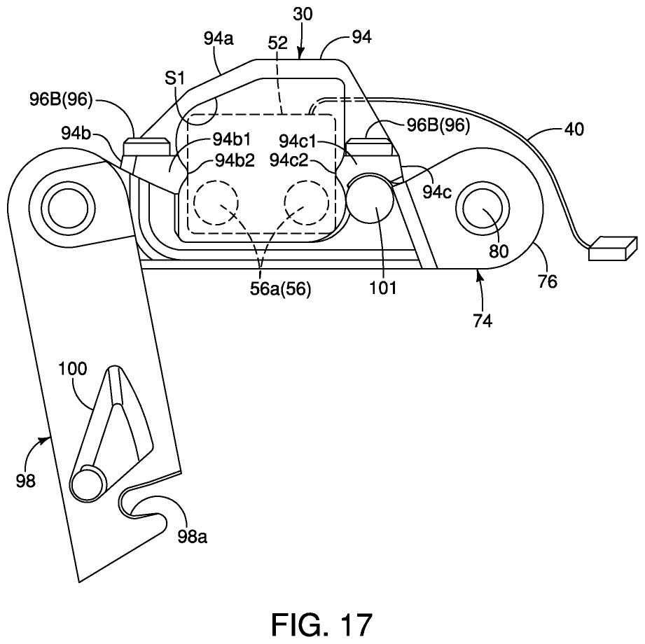

Here, as seen in FIGS. 16 and 17, the bicycle component BC further comprises a first electrical connection 56. Here, the first electrical connection 56 includes a pair of electrical terminals 56a that are provided to the circuit board 52 of the first battery holder 30. Thus, in the illustrated embodiment, the first battery holder 30 includes the first electrical connection 56. The first electrical connection 56 is configured to be directly connected to a first electrical terminal 50a of the first battery 50. Here, the first battery 50 includes a pair of the first electrical terminals 50a. The first electrical terminals 50a of the first battery 50 directly contact the electrical terminals 56a of the first electrical connection 56. In this way, the first battery 50 supplies electric power to the electrical part 28 via the circuit board 52 and the first electrical cable 40 (i.e., the flexible element). Also, preferably, the circuit board 52 is provided with a protection circuit for protecting the first battery 50 from being overcharged.

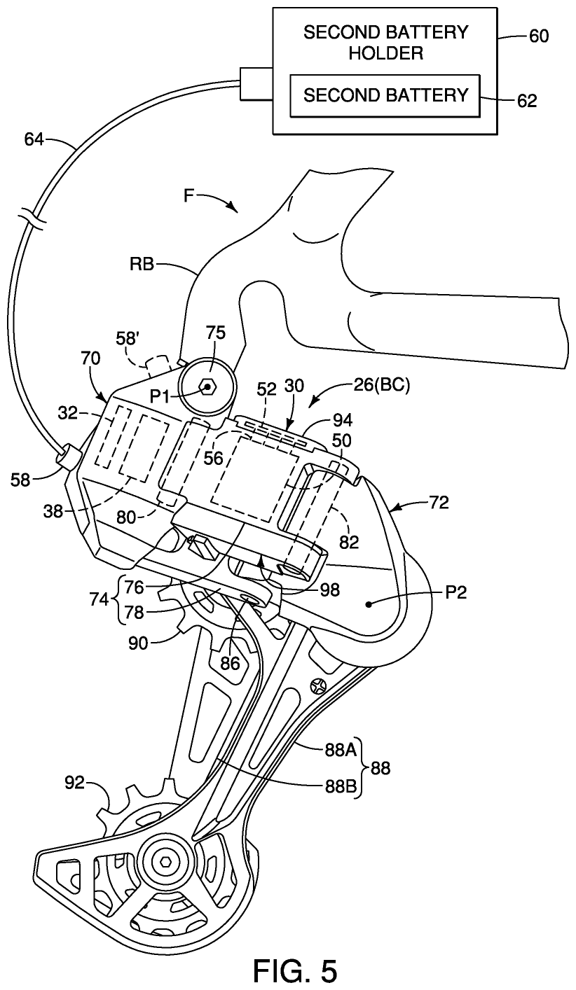

Preferably, in the illustrated embodiment, the bicycle component BC further comprises a second electrical connection 58. Here, the second electrical connection 58 is provided to a housing of the electrical part 28. As seen in FIG. 5, the second electrical connection 58 is at least partially located further from the mounting point P1 than the first electrical connection 56. Alternatively, the first electrical connection 56 is at least partially located further from the mounting point P1 than the second electrical connection 58. For example, this alternative location of the second electrical connection 58 is illustrated in dashed lines and indicated as 58′ in FIG. 5.

The second electrical connection 58 is electrically connected to the electrical part 28. In particular, the second electrical connection 58 is electrically connected to the circuit board 32 which in turn supplies the electric power to the electronic controller 34, the wireless communicator 36 and the actuator 38. In this way, the electrical part 28 can be supplied with electric power from another power source when the power level of the first battery 50 is below a prescribed power level. Thus, using the second electrical connection 58, as discussed below, the actuator 38 is configured to be connected to an additional electrical cable in a state where the actuator 38 is disconnected from the flexible element 40.

In the illustrated embodiment, as diagrammatically illustrated in FIGS. 3 to 6, the bicycle component assembly 10 further comprises a second battery holder 60 that is configured to hold a second battery 62. Preferably, the second battery 62 is electrically connected to the drive unit DU and one of the bicycle components BC. In the illustrated embodiment, the battery holder 60 and the second battery 62 are provided inside the downtube of the bicycle frame F. Alternatively, the battery holder 60 and the second battery 62 are provided on an exterior potion of the bicycle frame F. For example, the battery holder 60 and the second battery 62 can be provided on the downtube or seat tube of the bicycle frame F and the second battery 62 can be electrically connected to the drive unit DU and one of the bicycle components BC as in the case of some conventional e-bikes. Also, alternatively, the second battery 62 can be used to supply electric power to one or more of the bicycle components BC excluding the drive unit DU. For example, the battery holder 60 and the second battery 62 can be provided inside the seat tube of the bicycle frame F and the second battery 62 can be electrically connected to at least one of the electric front derailleur 24 and the electric rear derailleur 26.

The second battery holder 60 is mounted to a part of the bicycle B at a remote location from the bicycle component BC having the first battery holder 30. In other words, the first battery holder 30 and the second battery holder 60 are not provided to the same bicycle component BC. In this way, the second electrical connection 58 is configured to be connected to a second electrical cable 64 that is electrically connected to the second battery 62. The second battery holder 60 can be directly connected to the second electrical connection 58 by the second electrical cable 64. Alternatively, the second battery holder 60 can be indirectly connected to the second electrical connection 58. For example, the second battery holder 60 can be electrically connected to the drive unit DU, and the second electrical cable 64 can electrically connect the drive unit DU to the second electrical connection 58. In this way, the electric power of the second battery 62 is supplied to the second electrical connection 58 via the drive unit DU.

Here, the second electrical cable 64 is an example of the additional electrical cable that is connected to the actuator 38 via the second electrical connection 58 in a state where the actuator 38 is disconnected from the flexible element 40. Here, the second electrical connection 58 is configured to be electrically connected to the second battery 62 via the second battery holder 60. As mentioned above, the second battery holder 60 is remotely located from the bicycle component BC. Of course, when the first battery 50 is electrically connected to the electrical part 28 and the power level of the first battery 50 is sufficient to operate the bicycle component BC, it is not necessary for the second electrical cable 64 to be connected to the second electrical connection 58. As diagrammatically illustrated in FIG. 4, the first battery holder 30 and the first battery 50 can be removed from the bicycle component BC such that the bicycle component BC receives electric power from the second battery 62.

However, as diagrammatically illustrated in FIGS. 3 to 6, when the first battery 50 and the second battery 62 are both electrically connected to the electrical part 28, then the electronic controller 34 can regulate the supply of electric power from the first battery 50 and the second battery 62. For example, the electronic controller 34 is configured to switch supply of electric power to the electrical part 28 from one of the first battery 50 and the second battery 62 to the other one the first battery 50 and the second battery 62 upon determining a power level of one of the first battery 50 and the second battery 62 is lower than the other one the first battery 50 and the second battery 62 while in a state where the first battery 50 is electrically connected to the first electrical connection 56 and the second battery 62 is electrically connected to the second electrical connection 58.

The second electrical connection 58 includes an electrical connector 58a. Preferably, the second electrical connection 58 is a pluggable connector that mates with an electrical connector 64a of the second electrical cable 64 by a plugging action. If the electrical connector 58a is a male connector, then the electrical connector 64a is a female connector. On the other hand, if the electrical connector 58a is a female connector, then the electrical connector 64a is a male connector.

The bicycle component BC further comprises a third electrical connection 65 electrically connected to the electrical part 28. Here, the third electrical connection 65 is connected to the circuit board 32 of the electrical part 28. The first electrical connector 40a and the third electrical connection 65 are pluggable connectors that mate with each other by a plugging action. If the third electrical connection 58 has a male connector, then the first electrical connector 40a is a female connector. On the other hand, if the electrical connection 58 has a female connector, then the first electrical connector 40a is a male connector.

Preferably, the third electrical connection 65 has an electrical connector with the same configuration as the electrical connector 58a of the second electrical connection 58. In this way, the electrical connector 64a can be connected to either the second electrical connection 58 or the third electrical connection 65. Accordingly, the third electrical connection 65 can be omitted if needed and/or desired. In other words, while the diagram in FIG. 3 shows the first electrical cable 40 (i.e., the flexible element) electrically connected to the third electrical connection 65 of the electrical part 28 and the second electrical cable 64 electrically connected to the second electrical connection 58, the third electrical connection 65 can be omitted where the first electrical cable 40 and the second electrical cable 64 are each configured to be selectively connected to the second electrical connection 58. In this configuration, only one of the first battery 50 and the second battery 62 can be connected at a time to the electrical part 28 via the second electrical connection 58. Thus, either the first electrical cable 40 is connected to the second electrical connection 58 to supply electric power via the first battery 50, or the second electrical cable 64 is connected to the second electrical connection 58 to supply electric power via the second battery 62.

The first battery 50 has a first electric power capacity, and the second battery 62 has a second electric power capacity larger than the first electric power capacity. Here, for example, the first battery 50 is a 7.4-volt, 300 mAh lithium-ion battery, while the second battery 62 is a 36-volt, 12.5 Ah lithium-ion battery that supplies electric power to the drive unit DU. Thus, to accommodate the different electric power capacities of the first battery 50 and the second battery 62, the bicycle component assembly 10 further comprises a circuitry configured to reduce at least one of voltage and current. In particular, the bicycle component BC further comprises a circuitry configured to reduce at least one of voltage and current. Thus, the circuitry converts current of the second battery 62 to a lower current supplied to the electrical part 28. The circuitry is disposed at one of the second electrical connection 58, the second battery holder 60, and the electrical part 28. Preferably, here, this circuitry is provided to the circuit board 32 of the electrical part 28 of the bicycle component BC.

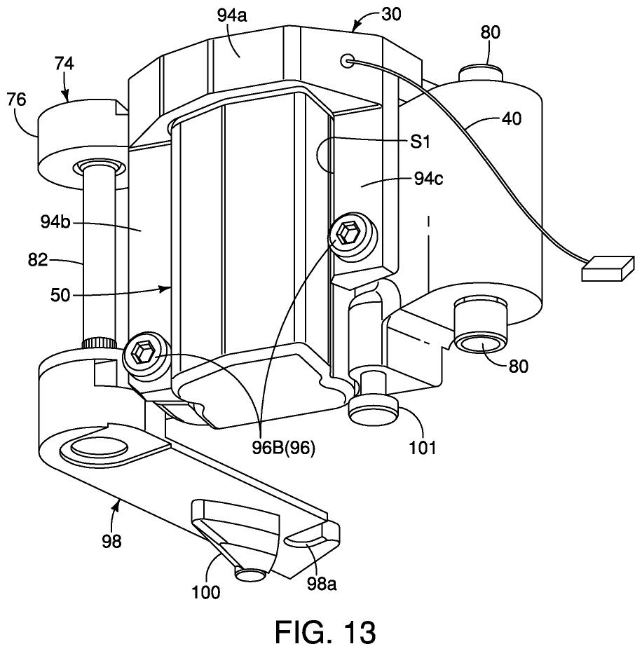

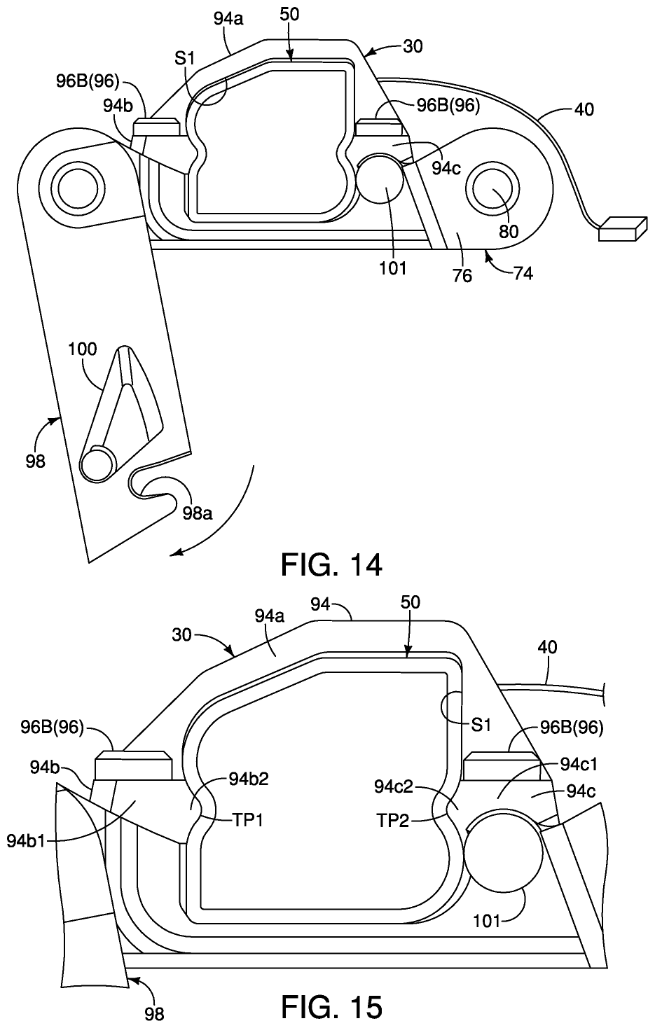

Referring now to FIGS. 4 to 15, the bicycle component assembly 10 will now be discussed in more detail using the electric rear derailleur 26 as one example of the bicycle component BC of the bicycle component assembly 10. For the sake of brevity, only the electrical rear derailleur 26 will be discussed in detail as example of the bicycle component BC of the bicycle component assembly 10 in the present disclosure.

In the bicycle component assembly 10, the electrical rear derailleur 26 can receive electric power from either the first battery 50 via the first electrical cable 40, or the second battery 60 via the second electrical cable 64. The first battery 50 is provided to the electrical rear derailleur 26, while the second battery 60 is located on the bicycle B at a remote location. For example, the second battery 60 can be a battery that supplies electric power to one or more electrical parts of the bicycle B.

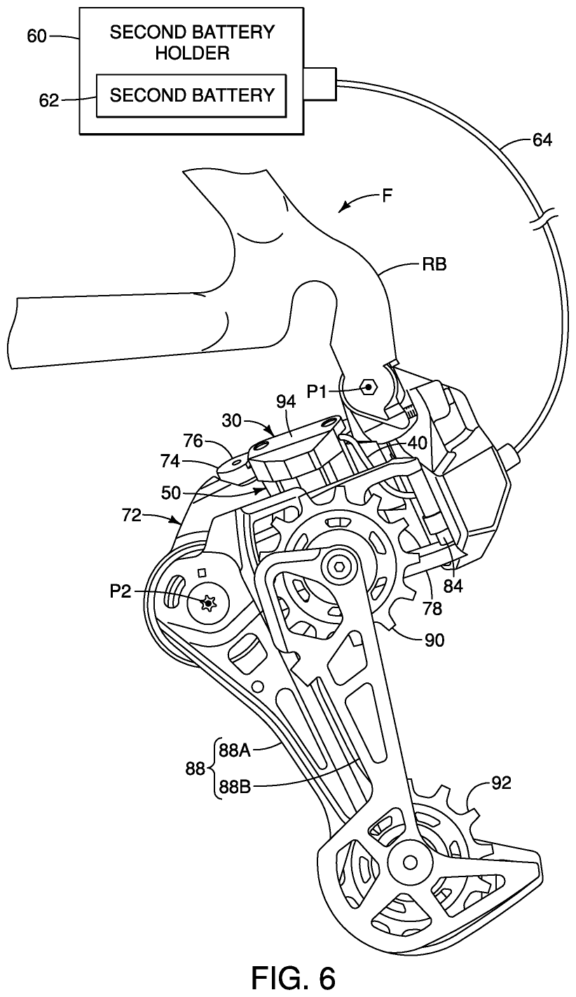

In the case of the bicycle component BC being the electrical rear derailleur 26, as seen in FIGS. 5 and 6, the bicycle component BC comprises the battery holder 30 (i.e., the first battery holder). Also, the bicycle component BC comprises the actuator 38. In the case of the bicycle component BC being the electrical rear derailleur 26, the bicycle component BC comprises a base member 70. The base member 70 is configured to be mounted to the bicycle frame F at a mounting point P1. In the case of the bicycle component BC being the electrical rear derailleur 26, the bicycle component BC further comprises a movable member 72 and a link member 74. Of course, the other bicycle components BC of the bicycle component assembly 10 include similar structures to the structures of the electrical rear derailleur 26, but wherein the structures are adapted to that particular bicycle component BC.

The base member 70 is configured to be mounted to the bicycle B by a fixing bolt 75, e.g., a fixing bolt. The movable member 72 is movably coupled to the base member 70 to move in a lateral direction with respect to the bicycle frame F. In the electrical rear derailleur 26, the link member 74 movably couples the movable member 72 to the base member 70. The actuator 38 is operatively coupled to the link member 74 to move the link member 74. Here, in the illustrated embodiment of the electrical rear derailleur 26, the actuator 38 is provided to the base member 70. Preferably, the actuator 38 includes a reversible electric motor and a reduction mechanism that are operably coupled to the link member 74.

The base member 70 is preferably constructed of a rigid material such as a lightweight metal (e.g., an aluminum alloy) or a fiber reinforced plastic. The base member 70 is configured to be pivotally mounted to the bicycle frame F by the fixing bolt 75 about the mounting point P1 that defines a first pivot axis. The first pivot axis is sometimes called the B-axis. The base member 70 can also include a posture adjusting bolt for adjusting the posture of the base member 70 about the B-axis in a conventional manner. Here, for example, the base member 70 is directly mounted to a hanger portion of the bicycle frame F via the fixing bolt 75 that forms a B-axle. However, the base member 70 can be indirectly mounted to the bicycle frame F as needed and/or desired.

Here, in the illustrated embodiment of the electrical rear derailleur 26, the link member 74 includes a first link 76 and a second link 78. The first link 76 is partially located further from the bicycle center plane CP than the second link 78 in a state where the base member 70 is mounted to the bicycle frame F. In other words, the second link 78 is located closer to the bicycle center plane than the first link 76 in a state where the base member 70 is mounted to the bicycle frame F. Thus, in the illustrated embodiment, the first link 76 is an outer link, and the second link 78 is an inner link. Alternatively, the first link 76 can be an inner link, and the second link 78 can be an outer link. The first link 76 (i.e., the outer link) at least partially overlying the second link 78 (i.e., the inner link) as viewed from a direction facing toward the bicycle frame F that is configured to face the base member in a state where the base member 70 is attached to the bicycle frame F of the bicycle B.

The first link 76 is pivotally connected to the base member 70 by a first link pin 80 and pivotally connected to the movable member 72 by a second link pin 82. The second link 78 is pivotally connected to the base member 70 by a third link pin 84 and pivotally connected to the movable member 72 by a fourth link pin 86.

The movable member 72 is a rigid member made of a suitable material such as a metallic material or a fiber reinforced plastic material. As mentioned above, the movable member 72 is movably coupled to the base member 70 by the link member 74. A chain guide 88 is pivotally mounted to the movable member 72 so that the chain guide 88 can pivot about a second pivot axis P2, which is sometimes called the P-axis. The chain guide 88 is constructed of a suitable rigid material such as an aluminum alloy or a fiber reinforced plastic. The chain guide 88 basically includes a first chain cage plate 88A and a second chain cage plate 88B. In the illustrated embodiment, the first chain cage plate 88A is an outer chain cage plate, and the second chain cage plate 88B is an inner chain cage plate. Alternatively, the first chain cage plate 88A may be an inner chain cage plate, and the second chain cage plate 88B may be an outer chain cage plate. Also, here, the chain guide 88 further includes a guide pulley 90 and a tension pulley 92. The guide pulley 90 and the tension pulley 92 are rotatably disposed between the first chain cage plate 88A and the second chain cage plate 88B. The first chain cage plate 88A and the second chain cage plate 88B define a chain receiving slot for receiving the bicycle chain CN.

The first electrical connection 56 is located at one of the base member 70, the movable member 72 and the link member 74. The second electrical connection 58 is located at the one of the base member 70, the movable member 72 and the link member 74. The second electrical connection 58 is located at a different one of the base member 70, the movable member 72 and the link member 74 from the first electrical connection 56. In the case of the rear derailleur 26, the first electrical connection 56 is located at the link member 74, and the second electrical connection 58 is located at the base member 70.

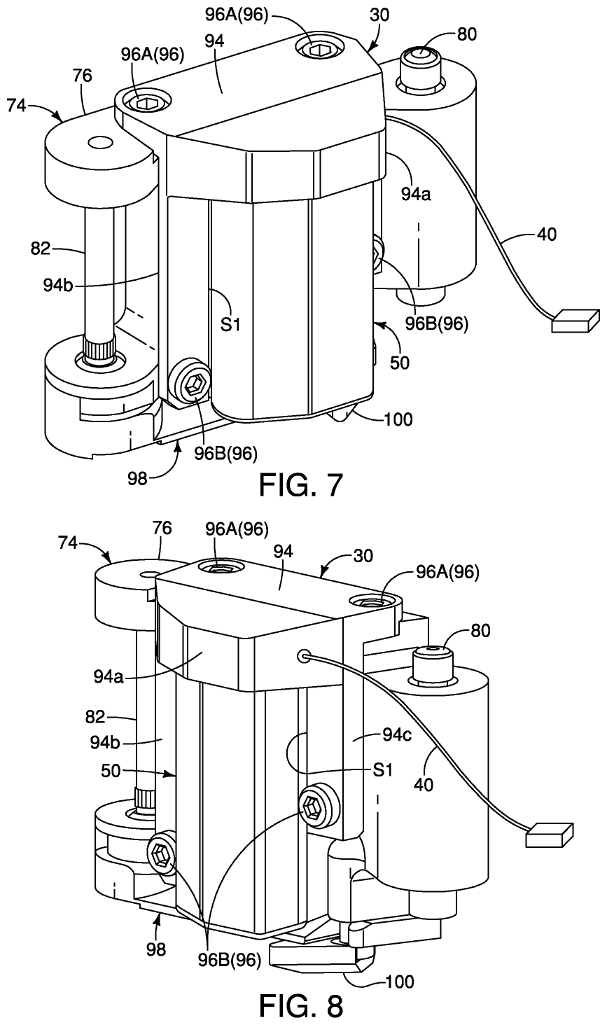

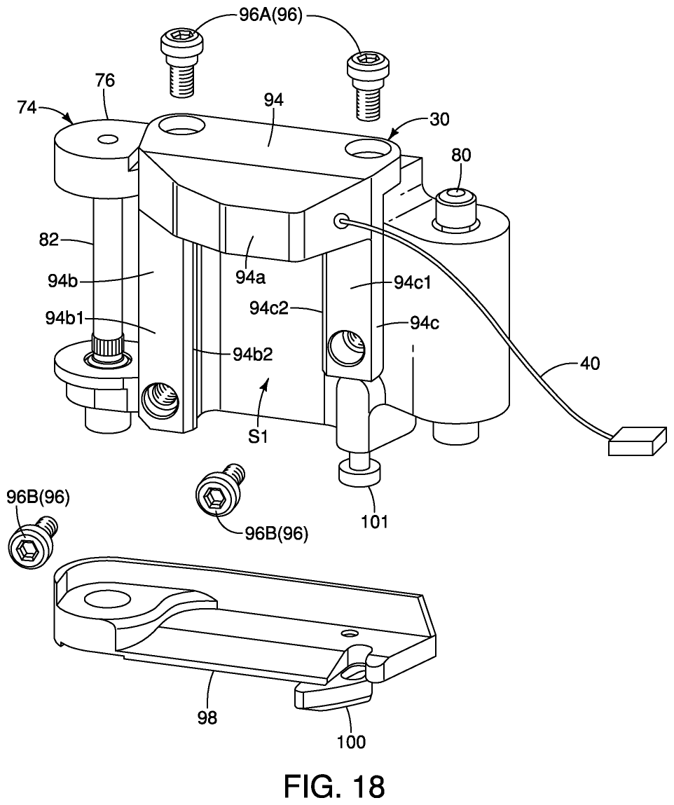

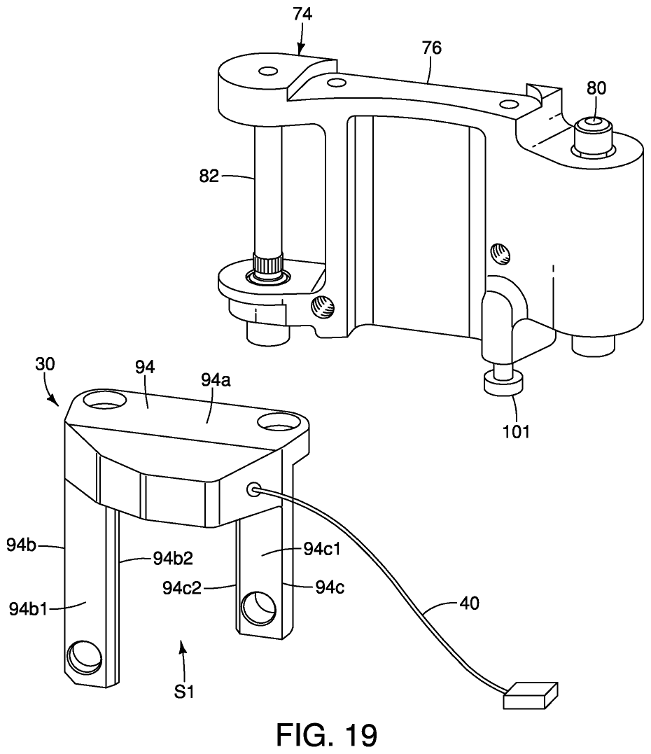

Now the battery holder 30 (i.e., the first battery holder) of the electrical rear derailleur 26 will be discussed in more detail with reference to FIGS. 7 to 19. The battery holder 30 (i.e., the first battery holder) is configured to hold the battery 50 (i.e., the first battery). Preferably, the battery holder 30 is detachably attached to at least one of the base member 70, the movable member 72 and the link member 74. Here, in the illustrated embodiment of the electrical rear derailleur 26, the battery holder 30 is detachably attached to the link member 74.

Basically, as seen in FIGS. 7 and 8, the battery holder 30 includes a battery holding portion 94 and the flexible element 40. The flexible element 40 electrically connects the battery holding portion 94 to the actuator 38. The flexible element 40 includes at least one of a first electrical cable and a flexible circuit board. Here, the flexible element 40 is an electrical cable. Thus, when referring to the electrical rear derailleur 26, the flexible element 40 will also be referred to as a first electrical cable 40. Although, as mentioned above, a flexible circuit board can be used instead of the first electrical cable 40 for the electrical rear derailleur 26. The first electrical cable 40 is electrically connected to the circuit board 52, which is provided to the battery holder 30. The first electrical connection 56 is provided to the circuit board 52 of the battery holder 30.

The battery holding portion 94 is configured to hold the battery 50 (i.e., the first battery). As explained later in more detail, the battery holding portion 94 is configured to detachably hold the battery 50. In accordance with certain aspects of the present disclosure, the battery 50 can be non-detachably coupled to the battery holder 30. The battery holding portion 94 is preferably constructed of a rigid material such as a lightweight metal (e.g., an aluminum alloy) or a fiber reinforced plastic.

Preferably, the battery holding portion 94 is located at least partially between the first link 76 and the second link 78. More preferably, the battery holding portion 94 is located between the first link pin 80 and the second link pin 82. In the illustrated embodiment, the battery holding portion 94 of the battery holder 30 includes a base portion 94a and a first extending portion 94b extending from the base portion 94a. In other words, the battery holder 30 includes the base portion 94a and the first extending portion 94b. Here, the battery holding portion 94 of the battery holder 30 includes the second extending portion 94c. In other words, the battery holder 30 further includes the second extending portion 94c. The second extending portion 94c extends from the base portion 94a. Thus, the first extending portion 94b and the second extending portion 94c are not directly coupled each other. Rather, the first extending portion 94b and the second extending portion 94c are coupled via the base portion 94a. The base portion 94a, the first extending portion 94b and the second extending portion 94c are configured to define a battery holding space S1 for receiving the battery 50.

As seen in FIG. 16, the bicycle component BC further comprises a seal member 95 located on the battery holder 30, and configured to seal an interface between the battery holder 30 and the battery 50 in a state where the battery 50 is located in the battery holding space S1. The seal member 95 is a sealing ring made of a suitable material such as an elastomeric material. Preferably, the seal member 95 is slightly compressed when the battery 50 is fully seated in the battery holding space S1. In this way, the electrical connection between the electrical terminals 50a of the battery 50 and the electrical terminals 56a the first electrical connection 56 are protected from contaminates.

As described below in more detail, the base portion 94a includes at least one electrical holder terminal configured to contact at least one electrical battery terminal 50a of the battery 50 upon sliding the battery 50 into the battery holding space S1. The electrical holder terminal is part of the first electrical connection 56 that electrically connects with the battery 50 upon sliding the battery 50 into the battery holding space S1. In this way, the battery 50 is electrically connected to the electrical holder terminals of the first electrical connection 56 that is provided to the circuit board 52 of the battery holder 30. In particular, the circuit board 52 is located in the base portion 94a of the battery holder 30 such that the electrical holder terminals of the first electrical connection 56 are at least partially exposed to the battery holding space S1 for contacting the electrical battery terminal 50a of the battery 50.

Here, the base portion 94a, the first extending portion 94b and the second extending portion 94c are integrally formed as a one piece member. Alternatively, one or both of the first extending portion 94b and the second extending portion 94c can be formed as a separate member that is attached to the link member 74. Preferably, the first extending portion 94b and the second extending portion 94c are parallel to each other. The first extending portion 94b is longer than the second extending portion 94c. The first extending portion 94b and the second extending portion 94c face each other across the battery holding space S1. As described below, the first extending portion 94b and the second extending portion 94c are configured to engage the battery 50 to restrict movement of the battery 50 in directions other than the battery insertion direction. The first extending portion 94b and the second extending portion 94c are cantilevered relative to the base portion 94a. While the battery holder 30 is illustrated with two extending portions (i.e., the first extending portion 94b and the second extending portion 94c in the illustrated embodiments), one of the first extending portion 94b and the second extending portion 94c can be omitted from the battery holder 30. For example, the second extending portion 94c does not have to be part of the battery holder 30 but could be integrally formed with the link member 74.

Referring now to FIG. 15, the first extending portion 94b includes a first main part 94b1 and a first contact part 94b2. The first contact part 94b2 has at least one of a first protrusion protruding from the first main part 94b1 toward the battery holding space S1 and a first recess recessed in the first main part 94b1 apart from the battery holding space S1. The second extending portion 94c includes a second main part 94c1 and a second contact part 94c2. The second contact part 94c2 has at least one of a second protrusion protruding from the second main part 94c1 toward the battery holding space S1 and a second recess recessed in the second main part 94c1 apart from the battery holding space S1. Here, the first contact part 94b2 and the second contact part 94c2 are configured as protrusions protruding towards each other and into the battery holding space S1. The first contact part 94b2 includes the first protrusion and the second contact part 94c2 includes the second protrusion. The first protrusion includes a first tapered part TP1 that tapers towards the battery holding space S1. The second protrusion includes a second tapered part TP2 that tapers towards the battery holding space S1. Alternatively, the first contact part 94b2 and the second contact part 94c2 can be configured as recesses that are recesses in a direction away from the battery holding space S1. Also, alternatively, one of the first contact part 94b2 and the second contact part 94c2 can be configured as a protrusion and the other one of the first contact part 94b2 and the second contact part 94c2 can be configured as a recess. In any case, the first contact part 94b2 and the second contact part 94c2 are configured to linearly guide and hold the battery 50 as the battery 50 slides into the battery holding space S1 during a battery attachment operation of the battery 50 to the battery holder 30. Preferably, the first contact part 94b2 and the second contact part 94c2 are arranged in a direction parallel to a link pin axis of the link member 74. In this way, the battery 50 is slidably attached to the battery holder 30 in a direction parallel to the link pin axis of the link member 74. The link pin axis is a longitudinal center axis of at least one of the first link pin 80 and the second link pin 82 about which the link member 74 pivots relative to at least one of the base member 70 and the movable member 72.

Referring now to FIGS. 7, 8 and 18, the battery holder 30 is configured to be fixed to at least one of the base member 70, the movable member 72 and the link member 74 by at least one screw 96. Here, in the illustrated embodiment of the electrical rear derailleur 26, the at least one screw 96 attaches the battery holder 30 to the link member 74. For example, the at least one screw 96 includes a pair of first screws 96A and a pair of second screws 96B. The first screws 96A attach the base portion 94a to the link member 74. The second screws 96B attach the first extending portion 94b and the second extending portion 94c to the link member 74. Alternatively, the battery holder 30 (i.e., the first battery holder) can be non-detachably fixed to the bicycle component BC (e.g., the electrical rear derailleur 26 in the illustrated embodiments). For example, the battery holder 30 can be formed integrally with one of the base member 70, the movable member 72 and the link member 74. For example, the battery holder 30 can be formed integrally with a part of the link member 74. Alternatively, the second extending portion 94c may be omitted from the battery holder 30 and be provided to the link member 74.

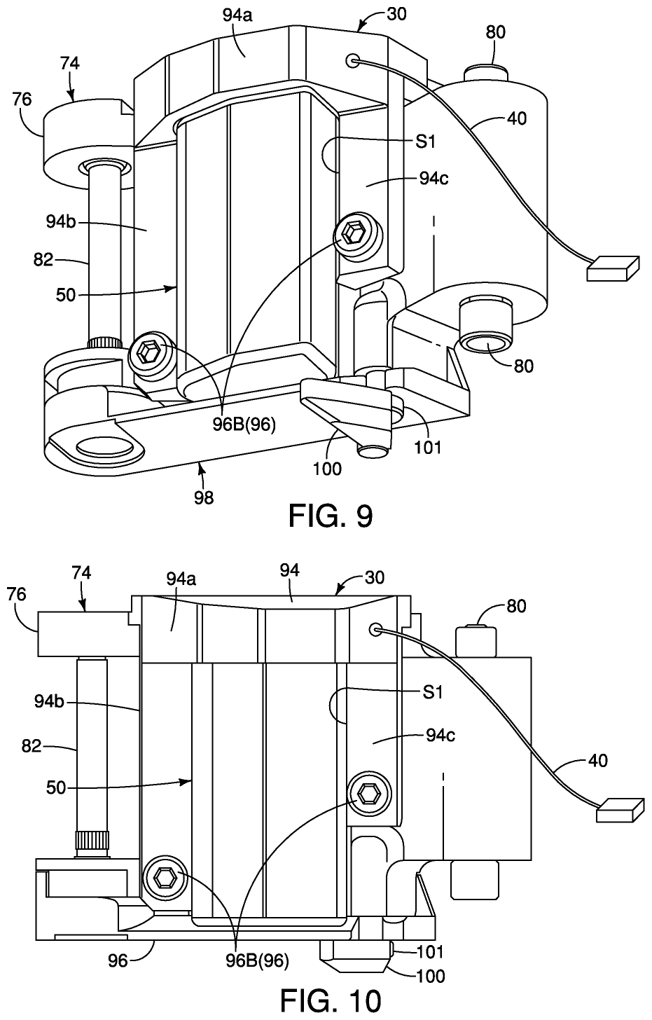

As seen in FIGS. 9 to 14, in the illustrated embodiment of the electrical rear derailleur 26, the bicycle component BC further comprises a locking member 98 movably mounted to at least one of the base member 70, the movable member 72 and the link member 74 between a first position and a second position. Here, the locking member 98 is movably mounted to the link member 74. More specifically, in the illustrated embodiment, the locking member 98 is a blocking bar that is pivotally mounted to the first link 76 of the link member 74. In particular, in the illustrated embodiments, the locking member 98 is pivotally mounted to the first link 76 to pivot around a center axis of the second link pin 82. When the locking member 98 is in the first position, the battery 50 can be inserted into the battery holding space S1. Thus, when the locking member 98 is in the first position, the locking member 98 does not block access to the battery holding space S1 for inserting the battery 50 into the battery holding space S1. The locking member 98 at least partially extends across the battery holding space S1 in the second position to hold the battery 50 in the battery holding space S1 in a state where the battery 50 is located in the battery holding space S1.

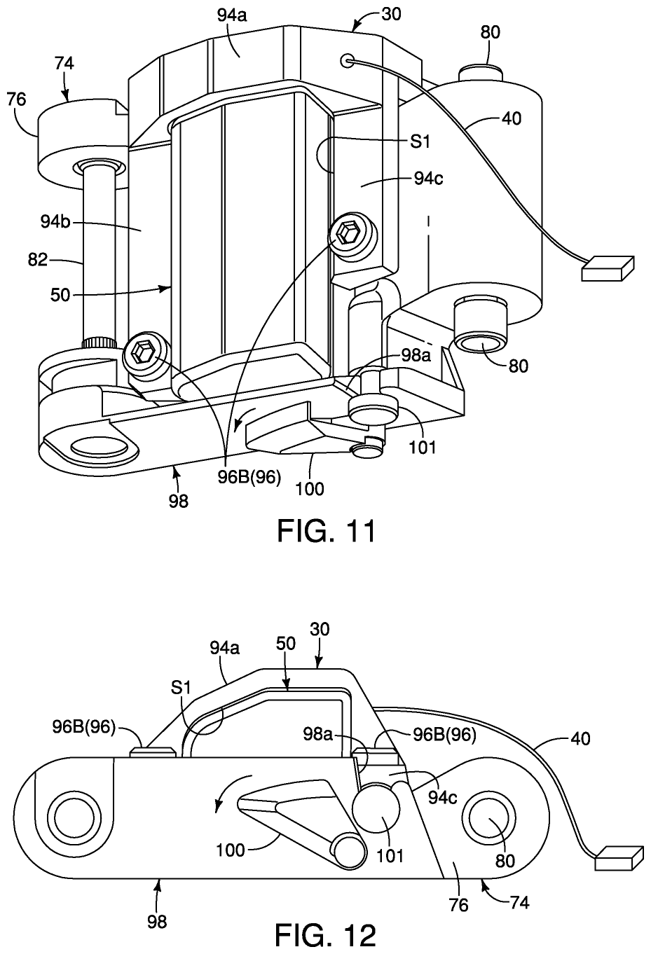

Referring to FIGS. 9 to 14, here, a latch 100 is pivotally mounted to the locking member 98, and a locking pin 101 is mounted to the first link 76. The locking pin 101 is received in a notch 98a of the locking member 98 when the locking member 98 is in the second position as seen in FIG. 11. The latch 100 is configured to frictionally engage the locking pin 101 in a latched position as seen in FIGS. 9 and 10. The latch 100 is further configured to be released from locking pin 101 when the latch 100 is the pivoted to an unlatch position as seen in FIGS. 11 and 12. When the latch 100 is engaged with the locking pin 101 in the latched position, the locking member 98 is locked in the second position. On the other hand, when the latch 100 is disengaged from the locking pin 101 in the unlatched position, the locking member 98 is free to move between the first position and the second position.

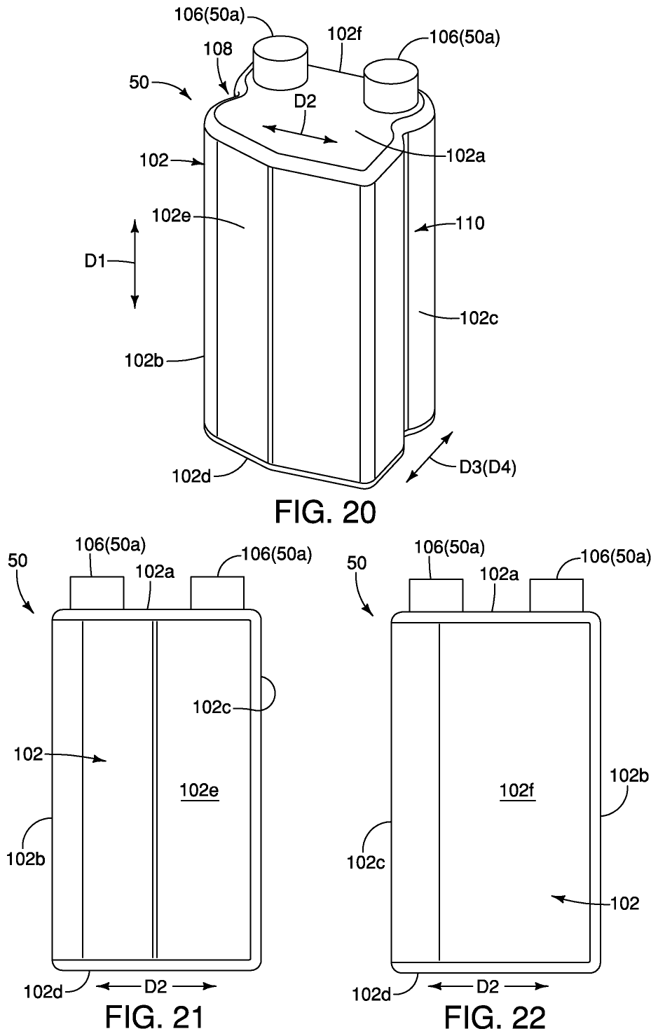

The battery 50 is configured to be held by the battery holder 30 of any one of the bicycle components BC of the bicycle B. Basically, as seen in FIG. 20, the battery 50 comprises a casing 102, at least one battery cell 104 and at least one electrical terminal 106. The electrical terminal 106 is indicated as electrical terminal 50a in the schematic diagram of FIG. 3. The at least one electrical terminal 106 is electrically connected to the at least one battery cell 104. More specifically, the base portion 94a is configured to be electrically connected to at least one electrical terminal 106 of the battery 50 in a state where the battery 50 is located in the battery holding space S1 between the first extending portion 94b and the second extending portion 94c. The at least one battery cell 104 has a first dimension X1 in the first direction D1 and a second dimension X2 in the second direction D2. The first dimension X1 is larger than the second dimension X2. Here, the at least one battery cell 104 includes two battery cells 104. Also, here, the at least one electrical terminal 106 includes two electrical terminals 106.

Basically, the casing 102 includes a top wall 102a, a first side wall 102b connects to the top wall 102a, and a second side wall 102c connects to the top wall 102a. The casing 102 further includes a bottom wall 102d connected to the first side wall 102b and the second side wall 102c at the end opposite to the top wall 102a. The casing 102 further includes a first connecting wall 102e and a second connecting wall 102f connecting the first side wall 102b and the second side wall 102c. The casing 102 is configured to be inserted into the battery holder 30 in a removably and reinstallable manner without damaging the battery 50 or the battery holder 30.

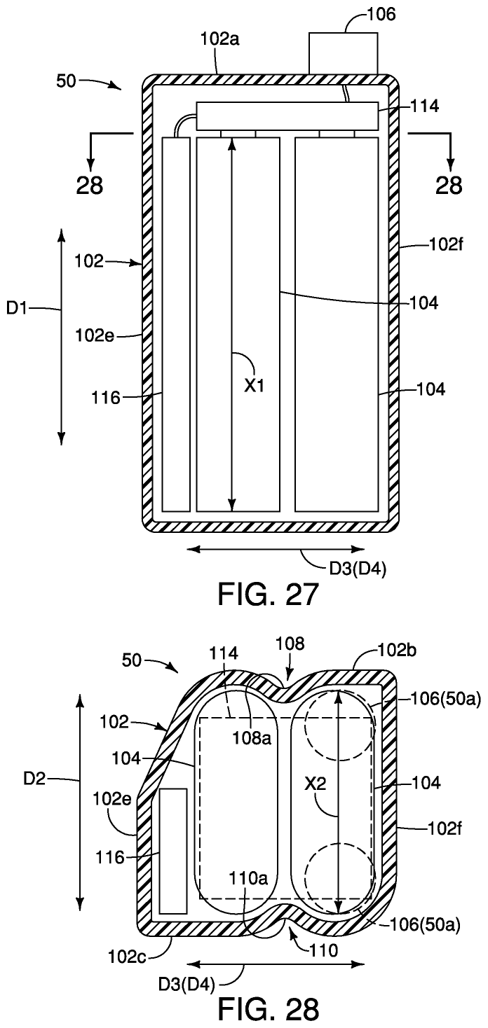

As seen in FIGS. 27 and 28, the two battery cells 104 are provided in the casing 102 such that the two battery cells 104 extend longitudinally in the casing 102 between the top wall 102a and the bottom wall 102b. The two electrical terminals 106 protrude from the top wall 102a. Thus, the at least one electrical terminal 106 is disposed at the top wall 102a. Here, the battery 50 is an elongated member. Specifically, the first side wall 102b and the second side wall 102c extend longitudinally in a first direction D1 of the casing 102 from the top wall 102a. Thus, the first direction D1 corresponds to the longitudinal direction of the battery 50. The at least one battery cell 104 is accommodated in the casing 102 between the first side wall 102b and the second side wall 102c in a second direction D2 different from the first direction D1. The second direction D2 is perpendicular to the first direction D1. The second direction D2 corresponds to a width direction of the battery 50. The two battery cells 104 are stacked in a fourth direction D4 different from the first direction D1. The fourth direction D4 is perpendicular to the first direction D1. In the illustrated embodiment, the fourth direction D4 is perpendicular to the first direction D1 and the second direction D2. Thus, the fourth direction D4 corresponds to a depth direction of the battery 50 where the second direction D2 corresponds to a width direction of the battery 50. The two electrical terminals 106 overlap one of the first cells 104 as viewed from the first direction D1 as seen in FIG. 28.

Here, the battery 50 further comprises a first contacting portion 108 and a second contacting portion 110. The first contacting portion 108 and the second contacting portion 110 are configured to contact the battery holder 30 and linearly slides in the first direction D1 during a battery attachment operation of the battery 50 to the battery holder 30. More specifically, the first contacting portion 108 and the second contacting portion 110 are configured to contact the first contact part 94b2 and the second contact part 94c2 of the battery holder 30 to linearly slides in the first direction D1 during a battery attachment operation of the battery 50 to the battery holder 30. The first contacting portion 108 has at least one of a first protrusion and a first recess. The second contacting portion 110 has at least one of a second protrusion and a second recess 108b. The at least one of the first protrusion and the first recess extends an entirety of the first side wall 102b in the first direction D1, and the at least one of the second protrusion and the second recess extends an entirety of the second side wall 102c in the first direction D1. Here, the first contacting portion 108 has a first recess 108a. Also, here, the second contacting portion 110 has a second recess 110a. However, one of the first contacting portion 108 and the second contacting portion 110 could have a protrusion and the other of the first contacting portion 108 and the second contacting portion 110 could have a recess. Alternatively, both the first contacting portion 108 and the second contacting portion 110 can each have a protrusion. Of course, the battery holder 30 would need to be modified to mate with the first contacting portion 108 and the second contacting portion 110 of the battery 50.

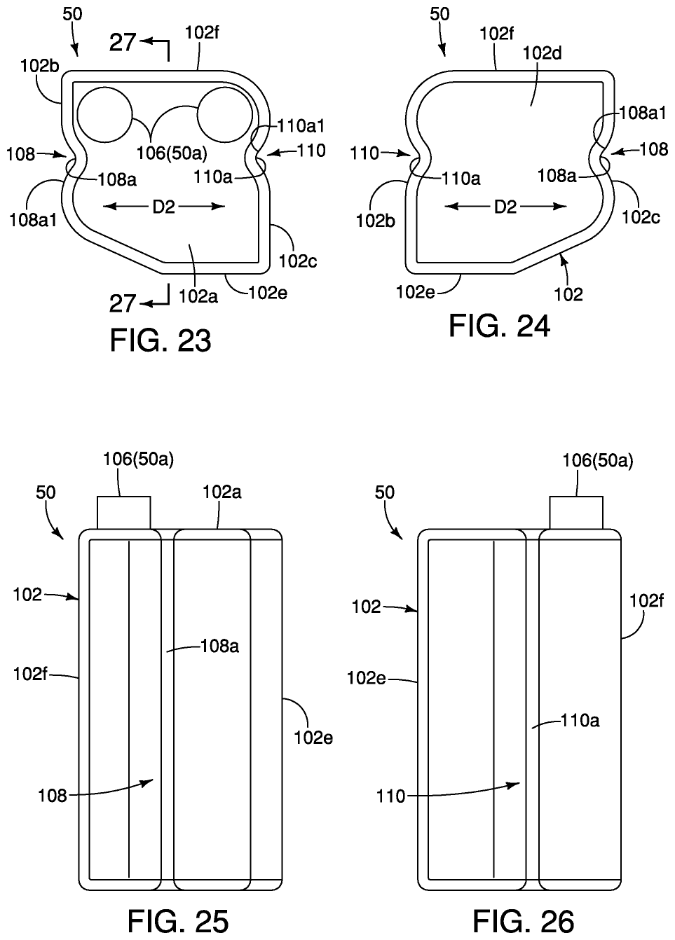

Preferably, as seen in FIGS. 23 and 24, the first recess 108a includes a first tapered recessed portion 108a1 tapering in the second direction D2 towards the second side wall 102c. The tapered recessed portion 108a1 is configured to receive the protrusion formed by the first tapered part TP1 of the first contact part 94b2 of the battery holding portion 94 of the battery holder 30. Preferably, also, the second recess 110a includes a second tapered recessed portion 110a1 tapering in the second direction D2 towards the first side wall 102b. The second tapered recessed portion 110a1 is configured to receive the protrusion formed by the second tapered part TP2 of the second contact part 94c2 of the battery holding portion 94 of the battery holder 30. In this way, the battery 50 can be installed to the battery holder 30.

As seen in FIGS. 27 and 28, the battery 50 further comprises at least one circuit board accommodated in the casing 102. The at least one circuit board includes a first circuit board 114 and a second circuit board 116. The first circuit board 114 is located between the at least one battery cell 104 and the at least one electrical terminal 106. The second circuit board 116 is aligned with the at least one battery cell 104 in a third direction D3 different from the first direction D1 and the second direction D2. The first circuit board 114 is electrically connected to the electrical terminals 106, and includes a protection circuit to protect the two battery cells 104 from being overcharged. The second circuit board 116 is electrically connected to the first circuit board 114. The second circuit board 116 may include a further protection circuit if the size of the first circuit board 114 is not large enough in size to protect the two battery cells 104 from being overcharged. Therefore, second circuit board 116 can be omitted if the first circuit board 114 is large enough in size to protect the two battery cells 104 from being overcharged.

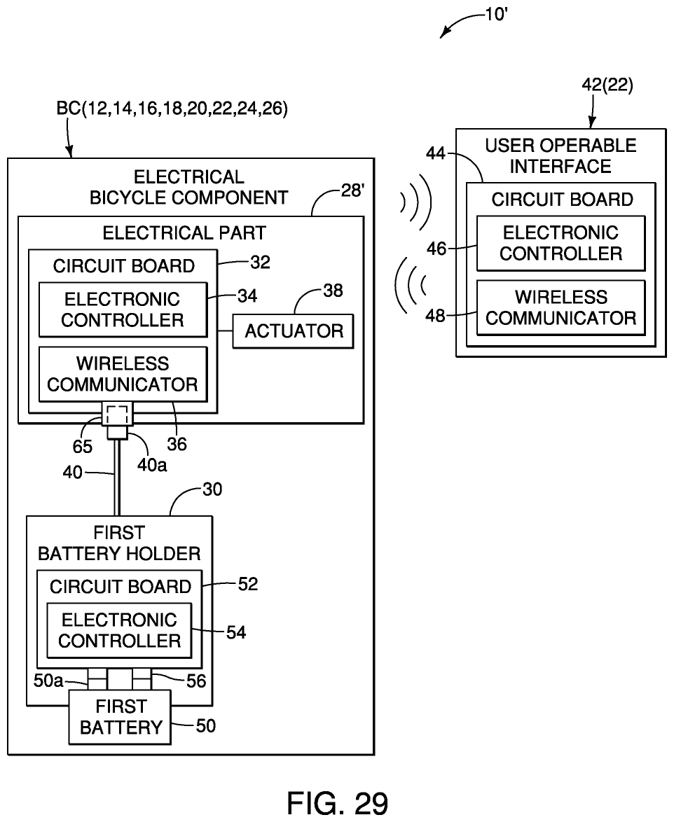

Referring now to FIG. 29, a schematic block diagram of a bicycle component system 10′ is illustrated in accordance with another embodiment. Here, the bicycle component system 10′ comprises a bicycle component other than a drive unit. Also, here, the bicycle component system 10′ is identical to the bicycle component system 10, except that the second electrical connection 58 of the bicycle component system 10 has been omitted from the bicycle component system 10′. In other words, an electrical part 28′ of the bicycle component system 10′ includes the third electrical connection 65 but does not include the second electrical connection 58. In view of the similarities between the bicycle component system 10 and the bicycle component system 10′, the parts that are identical will be given the same reference numeral. The bicycle component system 10′ is particularly suited for bicycle that does not have a large battery for a drive unit.

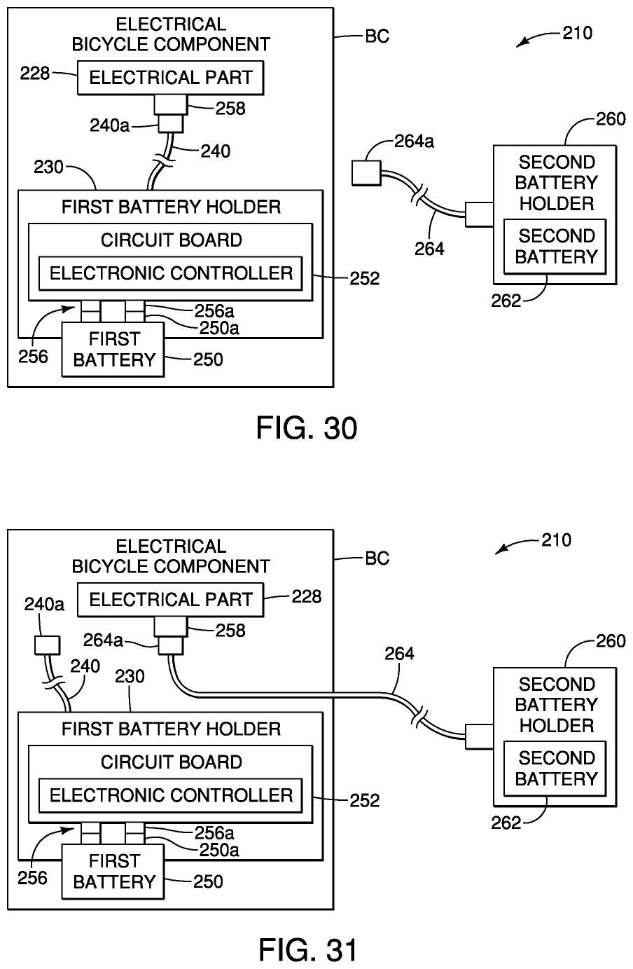

Referring now to FIGS. 30 and 31, a schematic block diagram of a bicycle component system 210 is illustrated in accordance with another embodiment. Here, the bicycle component system 210 comprises one of bicycle components BC of the bicycle of FIG. 1 other than a drive unit. Here, the bicycle component BC basically comprises an electrical part 228, a first battery holder 230 and a first electrical cable 240. The first electrical cable 240 is electrically connected to at least one electrical terminal of the first battery holder 230. The first electrical cable 240 is configured to be electrically connected to the electrical part 228 such that electric power can flow from the first battery holder 230 to the electrical part 228 via the first electrical cable 240 in a state where the first electrical cable 240 is electrically connected to the electrical part 228.

The first battery holder 230 is configured to hold a first battery 250. The electrical part 228, the first battery holder 230 and the first electrical cable 240 can have the same structure as the electrical part 28, the first battery holder 30, the first electrical cable 40 and the first battery 50, respectively. Thus, the descriptions of the electrical part 28, the first battery holder 30, the first electrical cable 40 and the first battery 50 apply to the electrical part 228, the first battery holder 230 and the first electrical cable 240, respectively.

Similar to the first embodiment, the first battery 250 of the bicycle component BC further comprises a first electrical connection 256. Here, the first electrical connection 256 includes a pair of electrical terminals 256a that are provided to a circuit board 252 of the first battery holder 230. The first electrical connection 256 is configured to be directly connected to a first electrical terminal 250a of the first battery 250. Here, the first battery 250 includes a pair of the first electrical terminals 250a. The first electrical terminals 250a of the first battery 250 directly contact the electrical terminals 256a of the first electrical connection 256.

The bicycle component BC further comprises an electrical connection 258, which can also be referred to as a second electrical connection. The electrical connection 258 is electrically connected to the electrical part 228. The electrical connection 258 is configured to receive electric power and supply that electric power to the components of the electrical part 228. The first electrical cable 240 is configured to be electrically connected to the electrical part 228 via the electrical connection 258 such that electric power can flow from the first battery holder 230 to the electrical part 228 via the first electrical cable 240 in a state where the first electrical cable 240 is electrically connected to the electrical part 228.

Similar to the electrical connection 58 and the first battery holder 30, the electrical connection 258 and the first battery holder 230 are arranged in the same positions as the electrical connection 58 and the first battery holder 30 shown in FIG. 5 when the bicycle component BC of the bicycle component system 210 corresponds to the electrical rear derailleur 26. In other words, the electrical connection 258 and the first battery holder 230 are arranged in the same positions as the electrical connection 58 and the first battery holder 30 shown in FIG. 5 such that the electrical connection 258 is at least partially located further from the mounting point P1 than the first battery holder 230. Alternatively, the electrical connection 258 and the first battery holder 230 are arranged in the same positions as the electrical connection 58′ and the first battery holder 30 shown in FIG. 5 such that the first battery holder 230 is at least partially located further from the mounting point P1 than the electrical connection 258.

The bicycle component assembly 10 further comprises a second battery holder 260 configured to hold a second battery 262. The bicycle component assembly 210 further comprises a second electrical cable 264 that is electrically connected to the second battery holder 260. The second battery holder 260 is electrically connected to the second battery 262. In this way, the second electrical cable 264 is electrically connected to the second battery 262. Further, the second electrical cable 264 is configured to be electrically connected to the electrical part 228 via the electrical connection 258 such that electric power can flow from the second battery holder 260 to the electrical part 228 via the second electrical cable 264 in a state where the second electrical cable 264 is electrically connected to the electrical part 228. Thus, the electrical connection 258 is configured to be selectively connected to the first electrical cable 240 and the second electrical cable 264 electrically connecting to the second battery 262. Thus, either the first battery 250 or the second battery 262 can be used for supplying electric power to the components of the electrical part 228.

Here, the second battery holder 260 is illustrated as being directly connected to the second electrical connection 258 by the second electrical cable 264. However, alternatively, the second battery holder 260 can be indirectly connected to the second electrical connection 258. For example, the second battery holder 260 can be electrically connected to the drive unit DU, and the second electrical cable 264 can electrically connect the drive unit DU to the second electrical connection 258. In this way, the electric power of the second battery 262 is supplied to the second electrical connection 258 via the drive unit DU.

Preferably, the second electrical cable 264 is configured to be used for power line communication. In other words, when the second electrical cable 264 is electrically connected to the electrical part 228, circuitry of the electrical part 228 includes a power line communication circuit and the second battery holder 260 includes a power line communication circuit. In this way, the bicycle component BC (e.g., the electrical rear derailleur 26) can communicate with other bicycle components BC that are connected to the second battery 262 via the second battery holder 260. The electrical part 228 of the bicycle component BC (e.g., the electrical rear derailleur 26) preferably includes the wireless communicator 36 of FIG. 3 such that the electrical part 228 of the bicycle component BC (e.g., the electrical rear derailleur 26) can wirelessly communicate with other bicycle components BC having a wireless communicator 36. In this way, the bicycle component BC (e.g., the electrical rear derailleur 26) can wirelessly communicate with other bicycle components BC when the second electrical cable 264 is not electrically connected to the electrical part 228 via the electrical connection 258.

More specifically, the electrical connection 258 is configured to be connected to the first electrical cable 240 in a state where the second electrical cable 264 is electrically disconnected from the electrical connection 258. Preferably, the electrical connection 258 is connected to the first electrical cable 240 in a state where the first battery 250 is attached to the first battery holder 230. In other words, the first battery 250 is attached to the first battery holder 230 such that the second electrical cable 264 can be disconnected from the electrical connection 258 and the first electrical cable 240 can be connected to the electrical connection 258.

Similarly, the electrical connection 258 is configured to be connected to the second electrical cable 264 of the second battery 262 in a state where the first electrical cable 240 is electrically disconnected from the electrical connection 258. Preferably, the electrical connection 258 is connected to the second electrical cable 264 in a state where the second battery 262 is attached to the second battery holder 260. In other words, the second battery 262 is attached to the second battery holder 260 such that the first electrical cable 240 can be disconnected from the electrical connection 258 and the second electrical cable 264 can be connected to the electrical connection 258. Thus, either the first battery 250 or the second battery 262 is connected to the electrical connection 258 to supply that electric power to the components of the electrical part 228.

Here, the first electrical cable 240 has a first electrical connector 240a, and the second electrical cable 264 has a second electrical connector 264a. Preferably, the second electrical connector 264a has the same structure as the first electrical connector 240a. In this way, the first electrical cable 240 and the second electrical cable 264 can be easily connected to the electrical connection 258 without any modifications, or additional connectors or adapters. Preferably, the first electrical connector 240a and the second electrical connector 264a are pluggable connectors that mate with the electrical connection 258 by a plugging action. If the electrical connection 258 has a male connector, then the first electrical connector 240a and the second electrical connector 264a are female connectors. On the other hand, if the electrical connection 258 has a female connector, then the first electrical connector 240a and the second electrical connector 264a are male connectors.

Similar to the prior embodiment, the first battery 250 has a first electric power capacity, and the second battery 262 has a second electric power capacity larger than the first electric power capacity. Here, for example, the first battery 250 is a 7.4-volt, 300 mAh lithium-ion battery, while the second battery 262 is a 36-volt, 12.5 Ah lithium-ion battery that supplies electric power to the drive unit DU. Thus, to accommodate the different electric power capacities of the first battery 250 and the second battery 262, the bicycle component assembly 210 further comprises a circuitry configured to reduce at least one of voltage and current. Thus, the circuitry converts current of the second battery 262 to a lower current supplied to the electrical part 228. Preferably, the circuitry is disposed at one of the electrical connection 258, the second battery holder 260, and the electrical part 228. Here, this circuitry is provided to the circuit board of the electrical part 228.

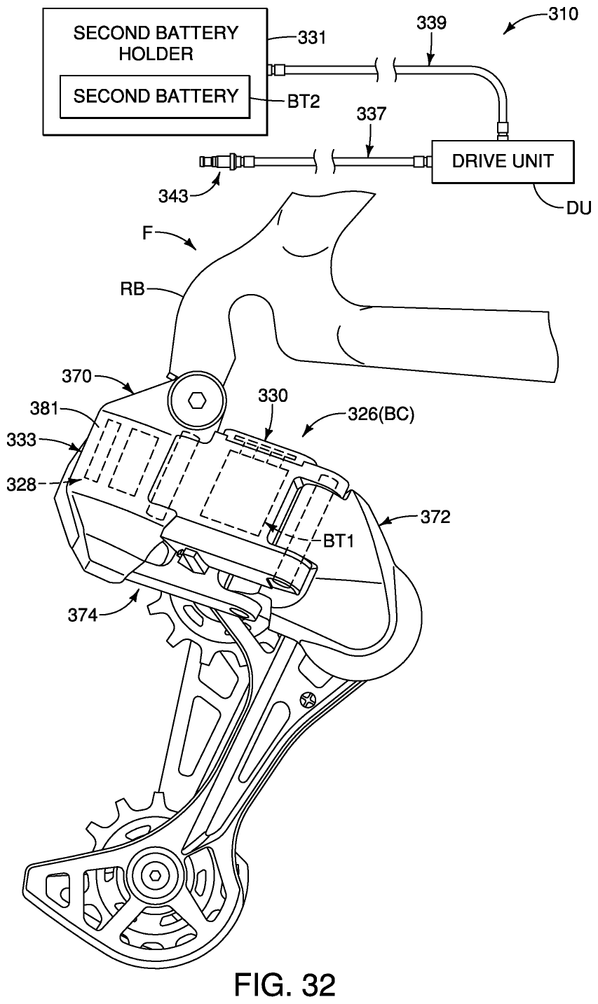

Referring now to FIGS. 32 to 45, a first bicycle component assembly 310 is illustrated in accordance with another embodiment. In this embodiment, as seen in FIGS. 32 to 35 and 45, the bicycle component assembly 310 basically comprises a first bicycle component BC1 having a first battery BT1, a drive unit DU and a second battery BT2. Here, in this embodiment, as seen in FIGS. 32 to 35, the bicycle component BC1 includes an electric rear derailleur 326. However, the first bicycle component BC1 can be for example, any one of an electric adjustable seatpost, an electric suspension, an electric brake device, an electric operating device and the electric transmission device. In any case, the bicycle component BC1 comprises an electrical part and an electrical connection. In the case of the electric rear derailleur 326 as the bicycle component BC1, the electric rear derailleur 326 comprises an electrical part 328 and an electrical connection 329. The electrical connection 329 is electrically connected to the electrical part 328. In this embodiment, the electric rear derailleur 326 includes an actuator unit 333 that includes the electrical part 328 and the electrical connection 329.

Basically, in this embodiment, the first bicycle component BC1 (e.g., the electric rear derailleur 326) is configured to selectively receive electrical power either from the first battery BT1 (i.e., a battery provided on the bicycle component), or from the second battery BT2 (i.e., a battery remotely located from the bicycle component). The electrical power from the second battery BT2 can be supplied directly to the electrical part 328 of the first bicycle component BC1 or via a junction or a another bicycle component. Here, the second battery BT2 is electrically connected to the drive unit DU, which in turn can be electrically connected to the electrical part 328 of the first bicycle component BC1 (e.g., the electric rear derailleur 326). In this way, the electrical power from the second battery BT2 is supplied to the drive unit DU and the electrical part 328 of the first bicycle component BC1 (e.g., the electric rear derailleur 326) via the drive unit DU.

As seen in FIGS. 32 to 35, the first battery BT1 is provided to the electric rear derailleur 326 by a first battery holder 330. In this way, the first battery BT1 is configured to be attached to the bicycle component BC. The first battery holder 330 is identical to the first battery holder 30 of the first embodiment. Also, the first battery BT1 is identical to the first battery 50 of the first embodiment. Thus, the first battery BT1 is removably from the first battery holder 330 in the same manner as the first embodiment. As a result, the first battery BT1 can be removed and reinstalled after being recharged. The voltage of the first battery BT1 is equal to or less than 9 volts. Preferably, the voltage of the first battery BT1 is equal to or less than 9 volts and equal to or more than 6 volts. Here, for example, the first battery BT1 is a 7.4-volt, 300 mAh lithium-ion battery. Since the first battery holder 330 is identical to the first battery holder 30 of the first embodiment, the description of the first battery holder 30 applies to the first battery holder 330. Likewise, since the first battery BT1 is identical to the first battery 50 of the first embodiment, the description of the first battery 50 applies to the first battery BT1. Accordingly, the first battery holder 330 and the first battery BT1 will not be described in further detail.

As mentioned above, the second battery BT2 is located on the bicycle B at a remote location from the first bicycle component BC1 (e.g., the electric rear derailleur 326). Preferably, the second battery BT2 is mounted to the bicycle B of FIG. 1 or to another bicycle component of the bicycle B by a second battery holder 331. The second battery holder 331 can be any type of battery holder. Preferably, the second battery holder 331 is configured such that the second battery BT2 can be removed from the second battery holder 331 and reinstalled to the second battery holder 331 after being recharged. The second battery BT2 is configured to supply electrical power to the drive unit DU that is configured to assist in propulsion of the bicycle B. The voltage of the second battery BT2 is equal to or less than 16 volts and more than 9 volts. Preferably, the voltage of the first battery BT1 is equal to or less than 16 volts and equal to or more than 12 volts. Here, for example, the second battery BT2 is a 16-volt, 12.5 Ah lithium-ion battery that supplies electric power to the drive unit DU. Thus, the second battery BT2 has a voltage higher than a voltage of the first battery BT1.

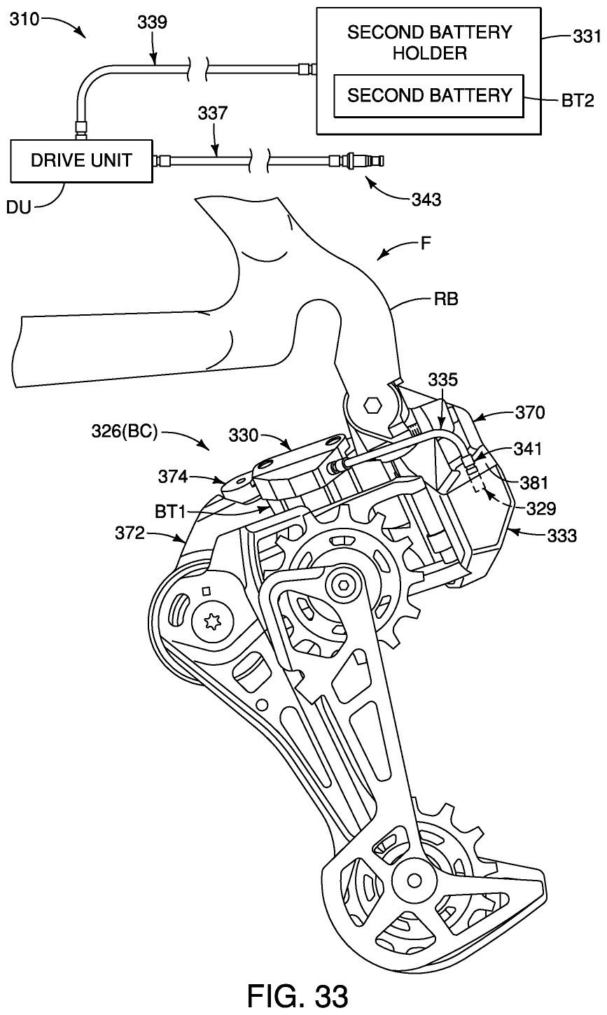

Here, as seen in FIGS. 32 and 33, the first battery BT1 can be electrically connected to the electrical connection 329 of the actuator unit 333 by a first electrical cable 335. More specifically, one end of the first electrical cable 335 is electrically connected to an electrical connection of the first battery holder 330, which is electrically connected to the first battery BT1. In this way, the first electrical cable 335 is configured to be electrically connected to the first battery BT1. The other end of the first electrical cable 335 is electrically connected to the electrical connection 329 of the actuator unit 333. As a result, the electrical power of the first battery BT1 can be supplied to the electrical part 328 of the actuator unit 333. In a case where the first electrical cable 335 is connected to the electrical connection 329 of the bicycle component BC, the second electrical cable 337 can be removed from the drive unit DU.

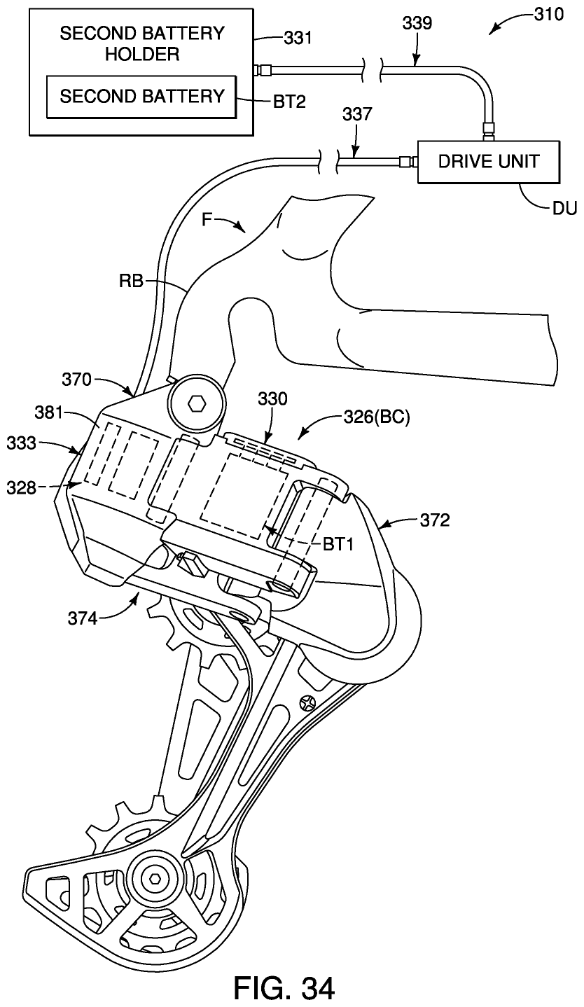

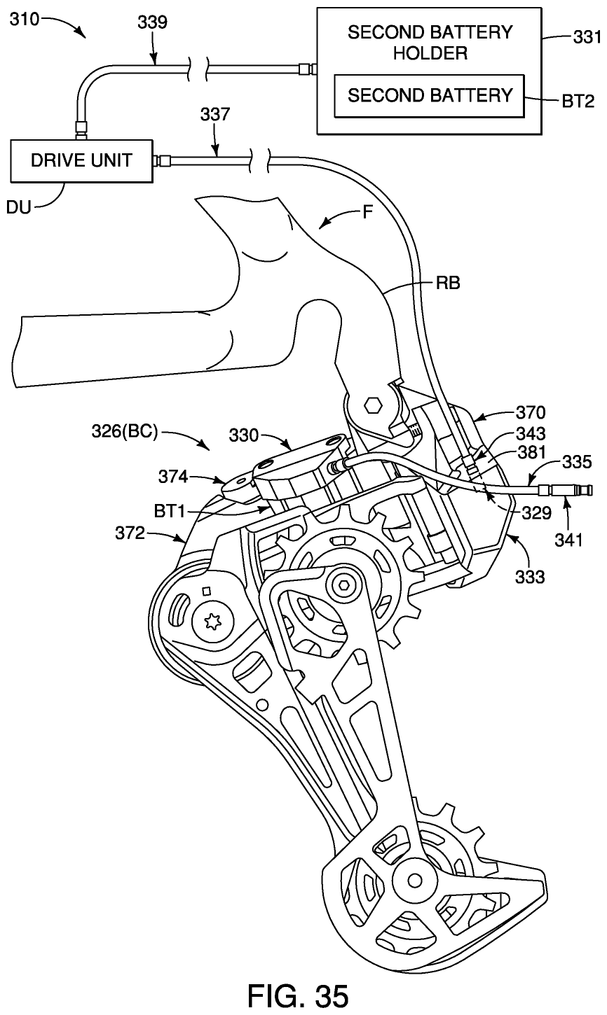

As seen in FIGS. 34 and 35, the drive unit DU can be electrically connected to the electrical connection 329 of the actuator unit 333 by a second electrical cable 337. The drive unit DU can be electrically connected to the second battery BT2 by a third electrical cable 339. In this way, the second electrical cable 337 is configured to be electrically connected to the second battery BT2. As a result, the electrical power of the second battery BT2 can be supplied to the electrical part 328 of the actuator unit 333 via the drive unit DU using the second electrical cable 337.

Alternatively, the second electrical cable 337 or the third electrical cable 339 can be directly connected between the second battery BT2 and the electrical connection 329 of the actuator unit 333 to supply electrical power directly from the second battery BT2 to the electrical part 328 of the actuator unit 333. Thus, the electrical connection 329 is configured to be selectively and electrically connected to one of the first electrical cable 335, the second electrical cable 337 and the third electrical cable 339. Here, the second electrical cable 337 and the third electrical cable 339 are identical or identical except for the length and/or cable diameter.

In a case where the second electrical cable 337 is connected to the electrical connection 329 of the bicycle component BC, the first battery BT1 is not used to supply electrical power to the electrical connection 329 of the bicycle component BC. Thus, the first battery BT1 can be removed in the case where the second electrical cable 337 is connected to the electrical connection 329 of the bicycle component BC. Alternatively, in the case where the first battery BT1 is removed, a dummy (fake) battery can be provided to a battery holding space of the first battery holder 330. In a case where the second electrical cable 337 is connected to the electrical connection 329 of the bicycle component BC, the first electrical cable 335 can be removed from the drive unit DU.

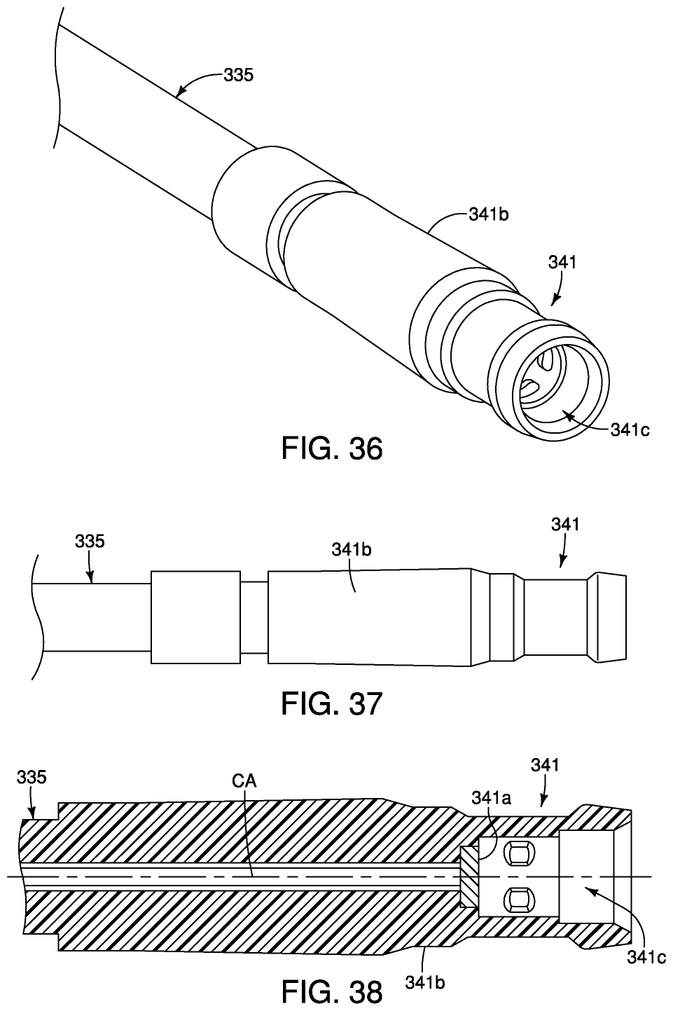

Referring to FIGS. 36 to 38, the first electrical cable 335 includes a first cable connector 341 that is configured to be electrically connected to the electrical connection 329. The first cable connector 341 is a pluggable type electrical connector that is pushed into the electrical connection 329 to electrically connect the first cable connector 341 to the electrical connection 329. The first cable connector 341 has a first shape. The first shape of the first cable connector 341 is configured to mate with the electrical connection 329 to electrically connect the first cable connector 341 to the electrical connection 329. Here, the first cable connector 341 is provided on a first end of the first electrical cable 335, while the second (opposite) end is electrically connected to the first battery BT1 via the first battery holder 330. Here, the electrical conductors of the first electrical cable 335 are connected to electrical terminals of the first battery holder 330. Alternatively, the second end of the first electrical cable 335 can be provided with a pluggable type connector similar to the first cable connector 341 that is pushed into an electrical connection of the first battery holder 330 for connecting to the first battery holder 330.

Basically, the first cable connector 341 includes a first connector contact portion 341a and a first cable connector housing 341b. The first connector contact portion 341a is electrically connected to the electrical conductors of the first electrical cable 335. The first cable connector housing 341b is formed of an electrical insulating material that partly covers the first connector contact portion 341a. Here, the first cable connector housing 341b is molded over the first connector contact portion 341a, and is integrally formed with the casing of the first electrical cable 335 as a one-piece member. Alternatively, the first cable connector 341 can be a separate member that is attached to the first electrical cable 335. The first cable connector housing 341b is configured to define a first electrical contact receiving space 341c. The first connector contact portion 341a is partly exposed in the first electrical contact receiving space 341c.

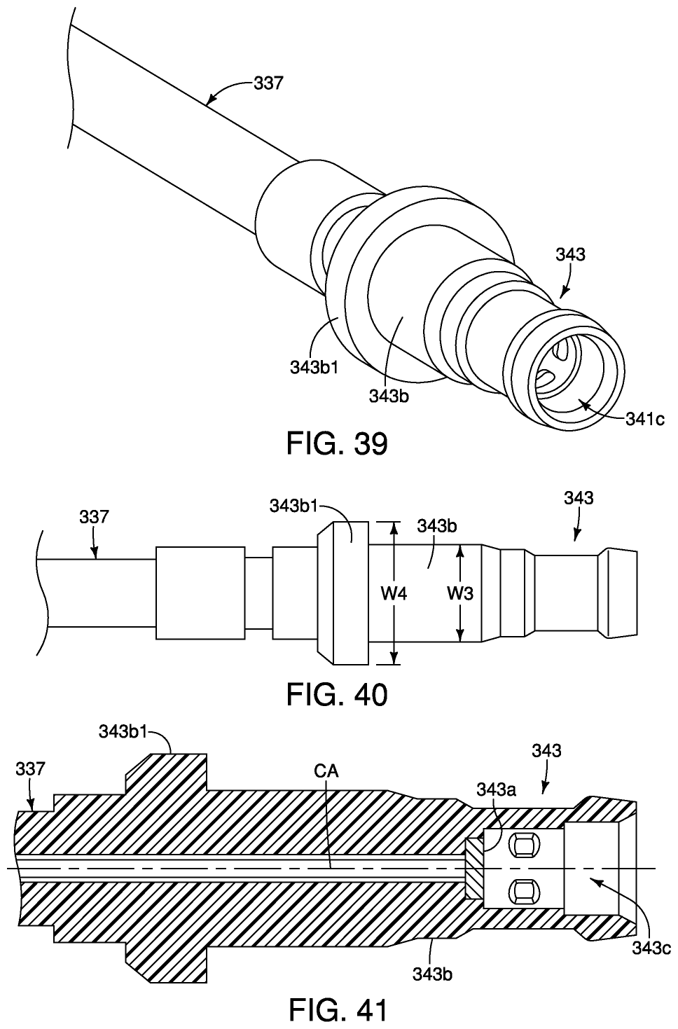

Referring to FIGS. 39 to 41, a cable connector 343 is provided for the electrical cable 337 that is connected to a first bicycle component. In other words, the second electrical cable 337 includes the second cable connector 343 that is configured to be electrically connected to the electrical connection 329 of the first bicycle component BC1 (e.g., the electric rear derailleur 326). The second cable connector 343 is a pluggable type electrical connector that is pushed into the electrical connection 329 to electrically connect the second cable connector 343 to the electrical connection 329. The second shape of the second cable connector 343 is configured to mate with the electrical connection 329 to electrically connect the second cable connector 343 to the electrical connection 329. The second cable connector 343 has a second shape. However, as explained below, the second shape is different from the first shape. Thus, here, the electrical connection 329 is configured to be selectively and electrically connected to the first cable connector 341 of the first electrical cable 335 and the second cable connector 343 of the second electrical cable 337. Here, the second cable connector 343 is provided on a first end of the second electrical cable 337, while a third cable connector 345 is provided on a second (opposite) end of the second electrical cable 337. Here, the second cable connector 343 and the third cable connector 345 are identical. Alternatively, the third cable connector 345 can have a different shape from the second cable connector 343.

Basically, the cable connector 343 comprises a connector contact portion 343a. The connector contact portion 343a will also be referred to as a second connector contact portion. The second connector contact portion 343a is electrically connected to the electrical conductors of the second electrical cable 337. The second connector contact portion 343a is configured to be electrically connected to the electrical connection 329 of the actuator unit 333 as described below.

The cable connector 343 further comprises a cable connector housing 343b covering the connector contact portion 343a. The cable connector 343 has a tubular shape having a center axis CA. The cable connector housing 343b will also be referred to as a second cable connector housing. The second cable connector housing 343b is formed of an electrical insulating material that surrounds the second connector contact portion 343a. Here, the second cable connector housing 343b is molded over the second connector contact portion 343a, and is integrally formed with the casing of the second electrical cable 337 as a one-piece member. Alternatively, the second cable connector 343 can be a separate member that is attached to the second electrical cable 337. The second cable connector housing 343b is configured to define a second electrical contact receiving space 343c. The second connector contact portion 343a is partly exposed in the second electrical contact receiving space 343c.

The cable connector 343 further comprises an abutment portion 343b1. Here, the second cable connector housing 343b includes the abutment portion 343b1. In particular, the second cable connector housing 343b and the abutment portion 343b1 are integrally formed together as a one-piece member. Alternatively, the abutment portion 343b1 can be attached to the second cable connector housing 343b. The abutment portion 343b1 includes at least one flange extending in a circumferential direction relative to the center axis CA of the cable connector housing 343b. Here, the abutment portion 343b1 is a continuous annular flange that extends completely around the cable connector housing 343b. Alternatively, the abutment portion 343b1 can be a discontinuous flange.

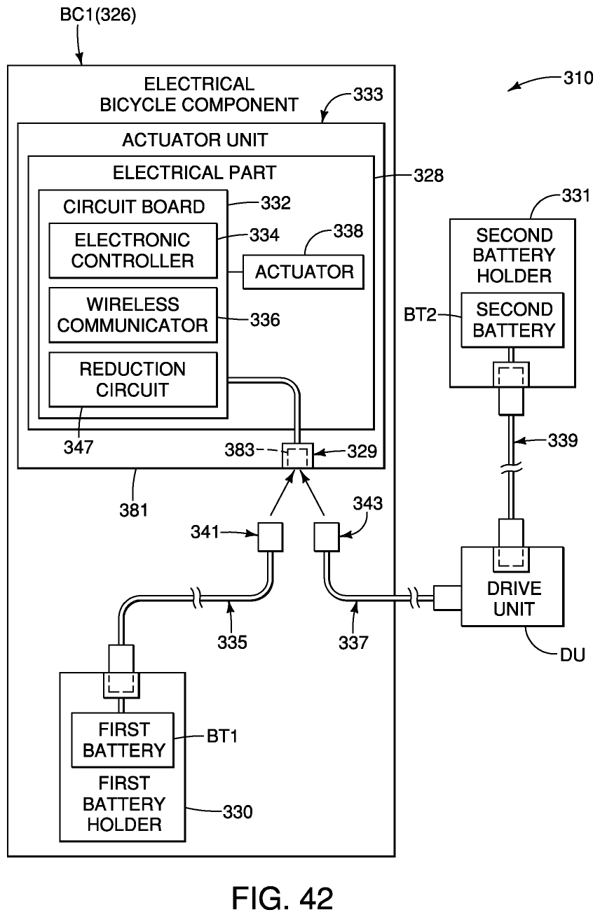

Referring to FIG. 42, an overall schematic block diagram of the first bicycle component assembly 310 in which either the first cable connector 341 or the second cable connector 343 can be electrically connected to the electrical connection 329. Here, similar to the first embodiment, the electrical part 328 includes a circuit board 332, an electronic controller 334 and a wireless communicator 336. In this embodiment, the electronic controller 334 and the wireless communicator 336 are provided on the circuit board 332. Here, the electrical part 328 further includes an actuator 338. The actuator 338 is electrically connected to the circuit board 332. In this embodiment, the electrical part 328 further includes a reduction circuit 347 for reducing at least one of voltage and current. The reduction circuit 347 is provided to the circuit board 332. The reduction circuit 347 can be configured to form a Buck converter. In this way, when the second electrical cable 337 is electrically connected to the electrical connection 329, the voltage and/or current of the electrical power from the second electrical cable 337 can be reduced to the appropriate level.

The parts (i.e., the circuit board 332, the electronic controller 334, the wireless communicator 336 and the actuator 338) of the electrical part 328 are the same as the parts (i.e., the circuit board 32, the electronic controller 34, the wireless communicator 36 and the actuator 38) of the electrical part 28, except that the circuit board 332 has been provided with the reduction circuit 347 as mentioned above. Thus, since the electrical part 328 is identical to the electrical part 28 of the first embodiment except for the addition of the reduction circuit 347, the above descriptions of the electrical part 28 applies to the electrical part 328.

Here, the electric rear derailleur 326 has a base member 370 configured to be mounted to the bicycle frame F. The electric rear derailleur 326 (i.e., the first bicycle component BC1) further comprises a movable member 372 and a link member 374. The first battery BT1 is provided to the link member 374 using the first battery holder 330 in the same manner has in the first embodiment. The actuator unit 333 is provided to the base member 370. Thus, the electrical part 328 is provided at the base member 370. The electric rear derailleur 326 is identical to the electric rear derailleur 26, except that the first battery holder 330 to have the first electrical cable 335 instead of the first electrical cable 40, and base member 370 have been modified to include the electrical connection 329 instead of the second electrical connection 58 and the third electrical connection 65.

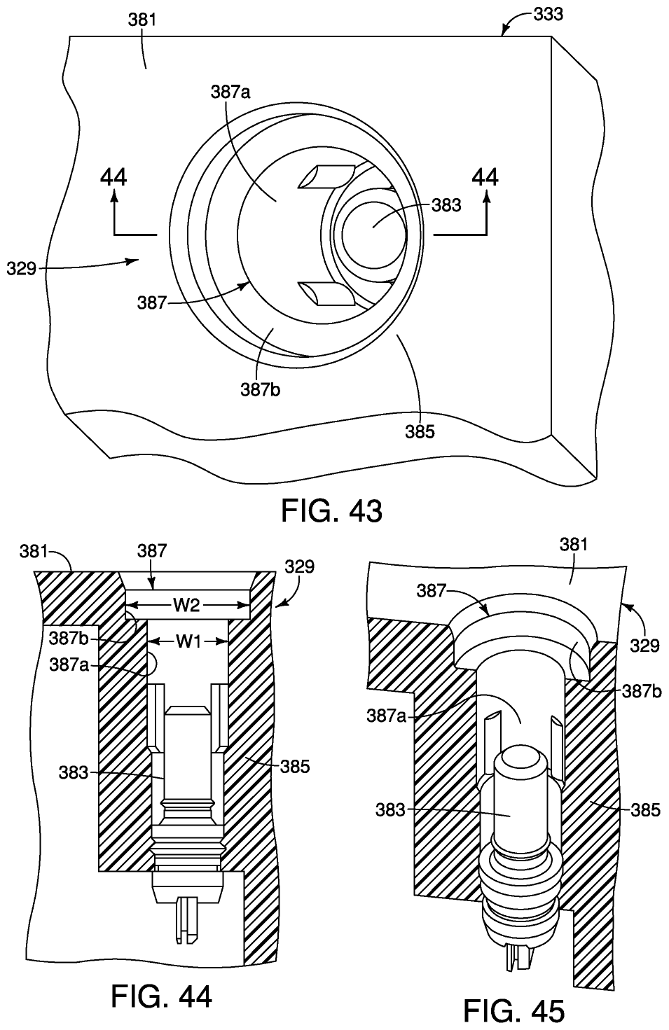

Referring to back to FIGS. 32 to 35, the bicycle component BC1 further comprises a housing 381 for accommodating the electrical part 328. In particular, the actuator unit 333 includes the housing 381 for accommodating the electrical part 328. The electrical connection 329 is provided to the housing 381 such that either the first cable connector 341 or the second cable connector 343 can be electrically connected to the electrical connection 329 for supplying electrical power to the electrical part 328. The electrical connection 329 is shown in more detail in FIGS. 43 to 47.

Referring now to FIGS. 43 to 47, the electrical connection 329 will now be discussed in more detail. Basically, the electrical connection 329 includes an electrical contact portion 383 and a connector housing 385 defining a connector receiving recess 387. In this embodiment, the connector housing 385 is integrally formed with the housing 381. In particular, in this embodiment, the connector housing 385 and the housing 381 are formed as a one-piece member. Here, the connector housing 385 is integrally mold with a part of the housing 381 from a suitable plastic material. The connector receiving recess 387 is configured to mate with the first cable connector 341 such that the electrical contact portion 383 of the electrical connection 329 is electrically connected to the first cable connector 341. Likewise, the connector receiving recess 387 is configured to mate with the second cable connector 343 such that the electrical contact portion 383 of the electrical connection 329 is electrically connected to the second cable connector 343.

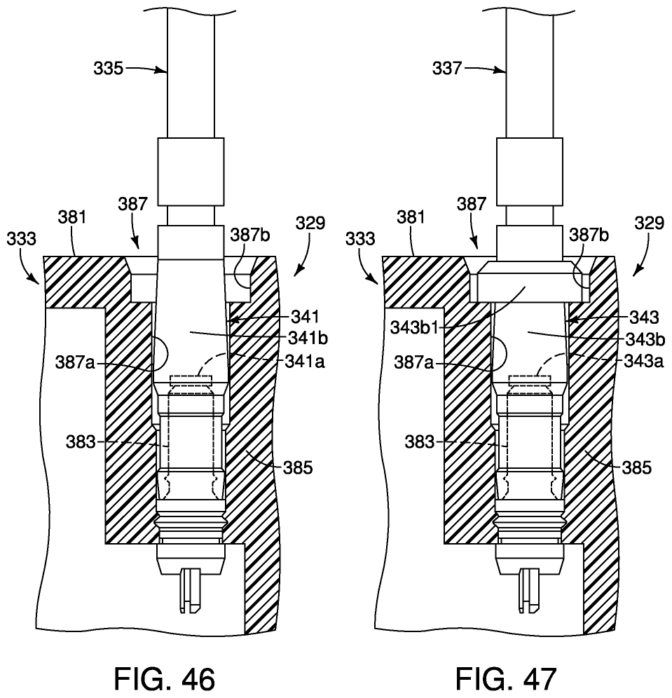

The electrical contact portion 383 is at least partly disposed in the connector receiving recess 387. The electrical contact portion 383 is located in the connector receiving recess 387 such that the electrical contact portion 383 of the electrical connection 329 contacts the first connector contact portion 341a of the first cable connector 341 when the first cable connector 341 is inserted into the connector receiving recess 387 as seen in FIG. 46. Thus, the first connector contact portion 341a is configured to electrically contact with the first electrical contact portion 383 of the first bicycle component BC1 in a state where the first cable connector 341 is connected to the first bicycle component BC1. In this embodiment, the first battery BT1 is not limited to a battery attached to the first bicycle component BC1 (i.e., the electric rear derailleur 326). In other words, the first battery BT1 can be located on another bicycle component or provided to the bicycle frame. For example, the first battery BT1 can be provided inside the seat tube of the bicycle frame and the first battery BT1 can be electrically connected to at least one the electric front derailleur 24 and the electric rear derailleur 326 (e.g., the first bicycle component BC1). Also, alternatively, the first battery BT1 can be provided inside the seat tube of the bicycle frame and connected to another bicycle component, while the second battery BT2 can be electrically connected to at least one of the electric front derailleur 24 and the electric rear derailleur 326 (e.g., the first bicycle component BC1).

Likewise, the electrical contact portion 383 is located in the connector receiving recess 387 such that the electrical contact portion 383 of the electrical connection 329 contacts the second connector contact portion 343a of the second cable connector 343 when the second cable connector 343 is inserted into the connector receiving recess 387 as seen in FIG. 47. Thus, the connector contact portion 343a is configured to electrically contact with the first electrical contact portion 383 of the first bicycle component BC1 in a state where the cable connector 343 is connected to the first bicycle component BC1. The connector receiving recess 387 includes a first recess 387a having a first width W1 and a second recess 387b having a second width W2. The second width W2 is larger than the first width W1. The second recess 387b is configured to receive the abutment portion 343b1 of the second cable connector 343 to allow the second cable connector 343 to electrically connect of the electrical connection 329. In particular, the cable connector housing 343b has a third width W3. The third width W3 is equal to or slightly smaller than the first width W1. The abutment portion 343b1 has a fourth width W4. The fourth width W4 is larger than the third width W3. The fourth width W4 is also larger than the W1. The fourth width W4 is equal to or slightly smaller than the second width W2. In this way, the second cable connector 343 is inserted into the connector receiving recess 387 as seen in FIG. 47.

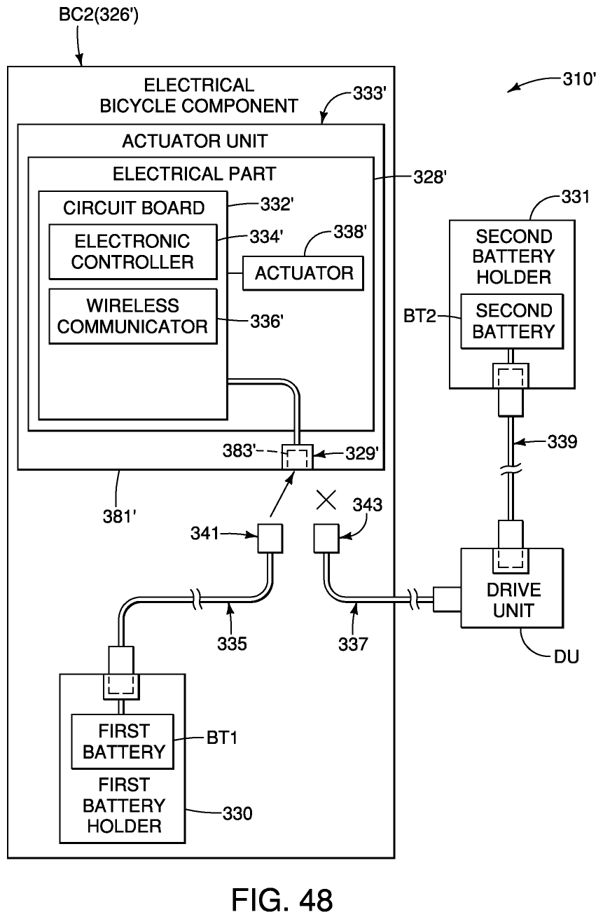

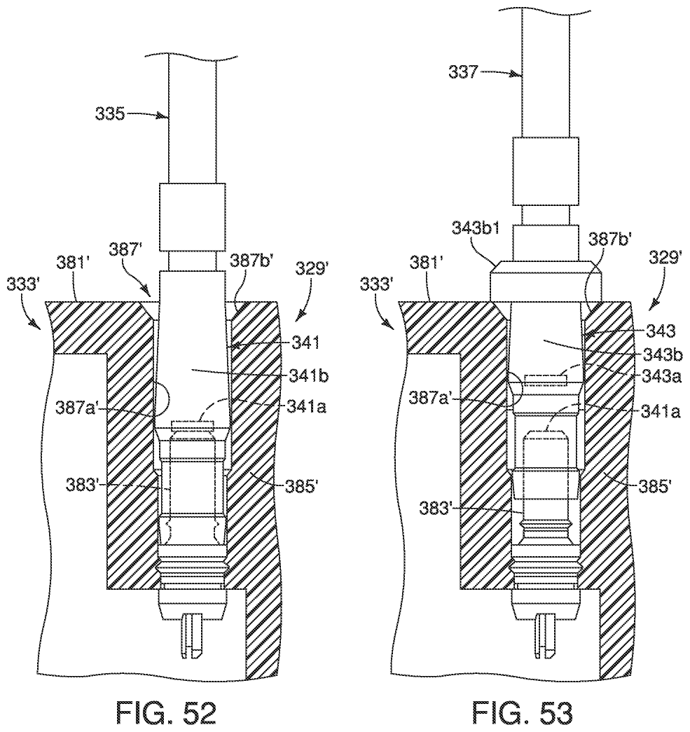

Referring to FIGS. 48 to 53, a second bicycle component assembly 310′ is illustrated is illustrated in accordance with another embodiment. In view of the similarities between the first bicycle component assembly 310 and the second bicycle component assembly 310′, parts that are identical may use the same reference symbol. As diagrammatically illustrated in FIG. 48, the second bicycle component assembly 310′ includes an electric rear derailleur 326′ (i.e., a second bicycle component BC2). Here, the first battery BT1 can be electrically connected to an electrical connection 329′ of an actuator unit 333′ using the first electrical cable 335 by plugging the first cable connector 341 into the electrical connection 329′, similar to the prior embodiment. However, the electrical connection 329′ is not compatible with the second cable connector 343. In particular, the actuator unit 333′ of the electric rear derailleur 326′ (i.e., the second bicycle component BC2) does not have a reduction circuit. Thus, the actuator unit 333′ cannot handle the higher voltage of the second battery BT.

The bicycle component assembly 310′ is identical to the bicycle component assembly 310, discussed above, except that the reduction circuit has been omitted and the electrical connection 329′ of the housing 381′ has been changed so that the second cable connector 343 cannot be electrically connected to the electrical connection 329′. Thus, descriptions of the components that are identical to components previously described will be omitted for the sake of brevity.

Similar to the prior embodiment, the actuator unit 333′ is provided with an electrical part 228′ that includes a circuit board 332′, the electronic controller 334′, a wireless communicator 336′ and an actuator 338′. The circuit board 332′ is identical to the circuit board 32 of the first embodiment as described above. The electronic controller 334′ is identical to the electronic controller 34 of the first embodiment as described above. The wireless communicator 336′ is identical to the wireless communicator 36 of the first embodiment as described above. The actuator 338′ is identical to the actuator 38 of the first embodiment as described above. Thus, since the electrical part 328′ is identical to the electrical part 28 of the first embodiment, the above descriptions of the electrical part 28 applies to the electrical part 328′.

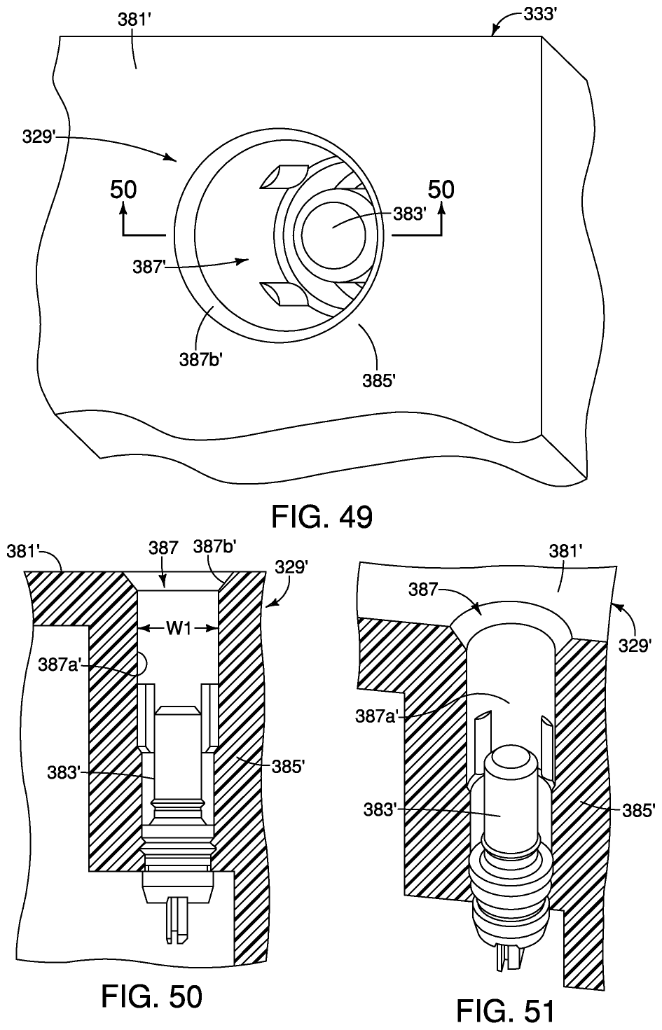

Referring to FIGS. 49 to 53, as mentioned above, the electrical connection 329′ of the housing 381′ is configured so that the second cable connector 343 cannot be electrically connected to the electrical connection 329′. However, the electrical connection 329′ of the housing 381′ is configured so that the first cable connector 341 can be electrically connected to the electrical connection 329′. In particular, the cable connector housing 343b has a shape, which is different from a shape of another cable connector (e.g., first cable connector 341) that is configured to be electrically connected to the second electrical contact portion 383′ of the second bicycle component BC2 (e.g., the electric rear derailleur 326′). In other words, the cable connector housing 343b has a shape so that the cable connector housing 343b cannot be electrically connected to the second electrical contact portion 383′ of the second bicycle component BC2.

The abutment portion 343b1 is configured to abut the second connector housing 385′ of the second bicycle component BC2 so as to prevent electrical contact with the second electrical contact portion 383′ of the second bicycle component BC2. On the other hand, the first cable connector 341 is shaped to fit into the connector receiving recess 387′ of the connector housing 385′ of the second bicycle component BC2.

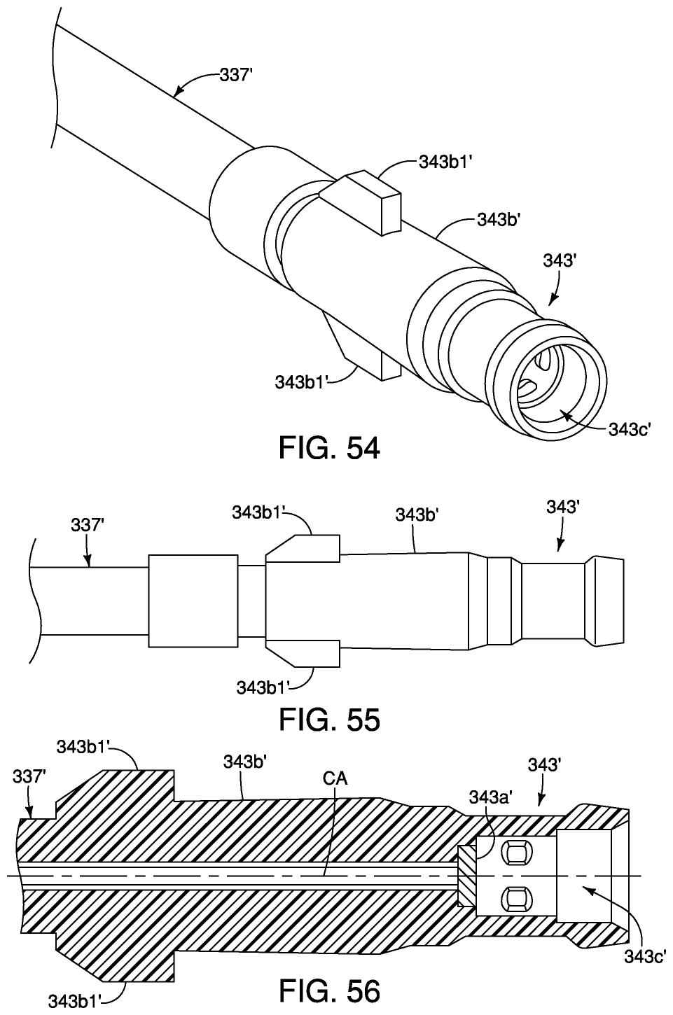

As seen in FIGS. 54 to 55, an alternate second electrical cable 337′ is illustrated that can be used with the first bicycle component BC1 (e.g., the electric rear derailleur 326). However, the second electrical cable 337′ cannot be electrically connected to the second bicycle component BC2 (e.g., the electric rear derailleur 326′). In particular, the second electrical cable 337′ has a second cable connector 343′ that includes a second connector contact portion 343a′ and a second cable connector housing 343b′ having an abutment portion 343b1′. The second cable connector housing 343b′ is configured to define a second electrical contact receiving space 343c′. Here, the abutment portion 343b1′ includes at least two flanges intermittently disposed in a circumferential direction relative to the center axis CA of the cable connector housing 343b′. It will be apparent from this disclosure that the abutment portion 343b1′ can have other shapes as needed and/or desired.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the bicycle component. Accordingly, these directional terms, as utilized to describe the bicycle component should be interpreted relative to a bicycle in an upright riding position on a horizontal surface and that is equipped with the bicycle component. The terms “left” and “right” are used to indicate the “right” when referencing from the right side as viewed from the rear of the bicycle, and the “left” when referencing from the left side as viewed from the rear of the bicycle.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle component comprising:
a base member;
a movable member;
a link member movably coupling to the movable member to the base member;
an actuator operatively coupled to the link member to move the link member; and
a battery holder detachably attached to the link member, the battery holder including a battery holding portion configured to hold a battery and a flexible element electrically connecting the battery holding portion to the actuator.

2. The bicycle component according to claim 1, wherein
the actuator is provided to the base member.

3. The bicycle component according to claim 1, wherein
the link member includes a first link and a second link, and
the battery holding portion is located at least partially between the first link and the second link.

4. The bicycle component according to claim 1, wherein
the link member includes a first link that is pivotally connected to the base member by a first link pin and pivotally connected to the movable member by a second link pin, and
the battery holding portion is located between the first link pin and the second link pin.

5. The bicycle component according to claim 1, wherein
the battery holding portion is configured to detachably hold the battery.

6. The bicycle component according to claim 1, wherein
the actuator is configured to be connected to an additional electrical cable in a state where the actuator is disconnected from the flexible element.

7. The bicycle component according to claim 1, wherein
the flexible element includes at least one of a first electrical cable and a flexible circuit board.

8. A bicycle component comprising:
an electrical part;
a first battery holder configured to hold a first battery;
a first electrical connection configured to be directly connected to a first electrical terminal of the first battery; and
a second electrical connection electrically connected to the electrical part and configured to be connected to a second electrical cable electrically connected to a second battery.

9. The bicycle component according to claim 8, wherein
the second electrical connection is configured to be electrically connected to the second battery via a second battery holder, the second battery holder remotely located from the bicycle component.

10. The bicycle component according to claim 8, further comprising:
a base member;
a movable member; and
a link member movably coupling to the movable member to the base member.

11. The bicycle component according to claim 10, wherein
the first electrical connection is located at one of the base member, the movable member and the link member, and
the second electrical connection is located at the one of the base member, the movable member and the link member.

12. The bicycle component according to claim 10, wherein
the first electrical connection is located at one of the base member, the movable member and the link member, and
the second electrical connection is located at a different one of the base member, the movable member and the link member from the first electrical connection.

13. The bicycle component according to claim 10, wherein
the first electrical connection is located at the link member, and
the second electrical connection is located at the base member.

14. The bicycle component according to claim 8, further comprising:
a base member configured to be mounted to a bicycle frame at a mounting point, wherein
the second electrical connection is at least partially located further from the mounting point than the first electrical connection.

15. The bicycle component according to claim 8, further comprising:
a base member configured to be mounted to a bicycle frame at a mounting point, wherein
the first electrical connection is at least partially located further from the mounting point than the second electrical connection.

16. The bicycle component according to claim 8, wherein
the second electrical connection includes an electrical connector.

17. The bicycle component according to claim 8, further comprising:
an electronic controller configured to switch supply of electrical power to the electrical part from one of the first battery and the second battery to the other one the first battery and the second battery upon determining a power level of one of the first battery and the second battery is lower than the other one the first battery and the second battery while in a state where the first battery is electrically connected to the first electrical connection and the second battery is electrically connected to the second electrical connection.

18. The bicycle component according to claim 8, wherein
the first battery holder includes the first electrical connection and a first electrical cable is configured to be connected to the second electrical connection.

19. The bicycle component according to claim 8, wherein
the first battery has a first electric power capacity, and the second battery has a second electric power capacity larger than the first electric power capacity.

20. The bicycle component according to claim 8, further comprising:
a circuitry configured to reduce at least one of voltage and current, and the circuitry being disposed at one of the second electrical connection, the second battery holder, and the electrical part.

21. A bicycle component comprising:
an electrical part;
a first battery holder configured to hold a first battery;
an electrical connection electrically connected to the electrical part; and
a first electrical cable electrically connected to at least one electrical terminal of the first battery holder,
the electrical connection being configured to be selectively connected to the first electrical cable and a second electrical cable electrically connected to a second battery,
the electrical connection being configured to be connected to the first electrical cable in a state where the second electrical cable is electrically disconnected from the electrical connection, and
the electrical connection being configured to be connected to the second electrical cable of the second battery in a state where the first electrical cable is electrically disconnected from the electrical connection.

22. The bicycle component according to claim 21, wherein
the first electrical cable has a first electrical connector, and the second electrical cable has a second electrical connector having a same structure as the first electrical connector.

23. A bicycle component assembly comprises the bicycle component according to claim 21, and further comprising:
a second battery holder configured to hold a second battery, and the second battery holder being remotely located from the bicycle component.

24. The bicycle component assembly according to claim 23, wherein
the electrical connection is connected to the first electrical cable in a state where the first battery is attached to the first battery holder, and
the second battery is attached to the second battery holder such that the first electrical cable can be disconnected from the electrical connection and the second electrical cable can be connected to the electrical connection.

25. The bicycle component assembly according to claim 23, wherein
the electrical connection is connected to the second electrical cable in a state where the second battery is attached to the second battery holder, and
the first battery is attached to the first battery holder such that the second electrical cable can be disconnected from the electrical connection and the first electrical cable can be connected to the electrical connection.

26. The bicycle component assembly according to claim 23, further comprising:
a circuitry configured to reduce at least one of voltage and current, and the circuitry being disposed at one of the electrical connection, the second battery holder, and the electrical part.

27. The bicycle component according to claim 21, further comprising:
a base member configured to be mounted to a bicycle frame at a mounting point, wherein
the electrical connection is at least partially located further from the mounting point than the first battery holder.

28. The bicycle component according to claim 21, further comprising:
a base member configured to be mounted to a bicycle frame at a mounting point, wherein
the first battery holder is at least partially located further from the mounting point than the electrical connection.

29. The bicycle component according to claim 21, wherein
the second electrical cable is configured to be used for power line communication.

30. The bicycle component according to claim 21, wherein
the bicycle component is a bicycle component other than a drive unit.

31. The bicycle component according to claim 21, wherein
the bicycle component includes one of an electric adjustable seatpost, an electric front suspension, an electric rear suspension, an electric front brake, an electric rear brake, an electric shift lever, an electric front derailleur, and an electric rear derailleur.

32. A bicycle component comprising:
an electrical part; and
an electrical connection electrically connected to the electrical part;
the electrical connection being configured to be selectively and electrically connected to a first cable connector of a first electrical cable and a second cable connector of a second electrical cable,
the first cable connector having a first shape and the second cable connector having a second shape, the second shape being different from the first shape.

33. The bicycle component according to claim 32, wherein
the first electrical cable is configured to be electrically connected to a first battery, and
the second electrical cable is configured to be electrically connected to a second battery, the second battery having a voltage higher than a voltage of the first battery.

34. The bicycle component according to claim 33, wherein
the second battery is configured to supply electrical power to a drive unit that is configured to assist in propulsion of a bicycle.

35. The bicycle component according to claim 33, wherein
the first battery is configured to be attached to the bicycle component.

36. The bicycle component according to claim 32, wherein
the electrical connection includes an electrical contact portion and a connector housing defining a connector receiving recess, the electrical contact portion is at least partly disposed in the connector receiving recess.

37. The bicycle component according to claim 36, wherein
the connector receiving recess includes a first recess having a first width and a second recess having a second width, the second width is larger than the first width.

38. The bicycle component according to claim 37, wherein
the second recess is configured to receive a connector abutment portion of the second cable connector to allow the second cable connector to electrically connect of the electrical connection.

39. The bicycle component according to claim 37, further comprising
a housing accommodating the electrical part, and
the connector housing being integrally formed with the housing.

40. The bicycle component according to claim 32, wherein
the bicycle component includes an electric rear derailleur having a base member configured to be mounted to a bicycle frame, the electrical part being provided at the base member.

41. The bicycle component according to claim 32, wherein
the electrical part includes a reduction circuit reducing at least one of voltage and current.

42. A cable connector for an electrical cable that is configured to be connected to a first bicycle component, the cable connector comprising:
a connector contact portion being configured to electrically contact with a first electrical contact portion of the first bicycle component in a state where the cable connector is connected to the first bicycle component; and
an abutment portion configured to abut a second connector housing of a second bicycle component so as to prevent electrical contact with a second electrical contact portion of the second bicycle component.

43. The cable connector according to claim 42, further comprising
a cable connector housing covering the connector contact portion, the cable connector having a tubular shape having a center axis, the abutment portion including at least one flange extending in a circumferential direction relative to the center axis of the cable connector housing.

44. The cable connector according to claim 42, further comprising
a cable connector housing covering the connector contact portion, the cable connector having a tubular shape having a center axis, the abutment portion including at least two flanges intermittently disposed in a circumferential direction relative to the center axis of the cable connector housing.

45. The cable connector according to claim 43, wherein
the cable connector housing has a shape, which is different from a shape of another cable connector configured to be connected to be electrically connected to the second electrical contact portion of the second bicycle component.

46. The cable connector according to claim 43, wherein
the cable connector housing has a third width,
the abutment portion has a fourth width, and
the fourth width is larger than the third width.
